(19) United States
(12) Patent Application Publication
(10) Pub. No.: US 2026/0058940 A1
(43) Pub. Date: Feb. 26, 2026

(54) SYSTEMS AND METHODS FOR PERFORMING TRANSACTIONS IN A DISTRIBUTED MULTIDEVICE ENVIRONMENT

(71) Applicant: Capital One Services, LLC, McLean, VA (US)

(72) Inventors: Casey Scott Barrett, Kensington, MD (US); Narmeen Rahman, Brooklyn, NY (US); Kevin Osborn, Newton Highlands, MA (US); Nicholas Graham, Lewisville, TX (US)

(21) Appl. No.: 19/305,412

(22) Filed: Aug. 20, 2025

Related U.S. Application Data
(60) Provisional application No. 63/685,475, filed on Aug. 21, 2024.

(51) Int. Cl. H04L 9/40; G06Q 20/34; G06Q 20/38

(52) U.S. Cl. CPC H04L 63/0442; G06Q 20/352; G06Q 20/3829; H04L 63/0807

(57) ABSTRACT

The systems and methods discussed enable users to perform functions in a multi-issuer environment. The systems and methods discussed herein enable card issuers or payment providers, such as banks, to issue contactless cards with tap-to functions to customers while maintaining high-level security. The systems and methods discussed herein further enable merchants to perform transactions and provide services across multiple devices in a distributed environment.

The present application claims priority to U.S. Provisional Patent Application No. 63/685,475, filed Aug. 21, 2024, the contents of which are incorporated by herein in their entirety.

### BACKGROUND

Contactless card products have become so universally well-known and ubiquitous that they have fundamentally changed the manner in which financial transactions and dealings are viewed and conducted in society today. Contactless card products are most commonly represented by plastic or metal card-like members that are offered and provided to customers through credit card issuers (such as banks and other financial institutions). With a card, an authorized customer or cardholder is capable of purchasing services and/or merchandise without an immediate, direct exchange of cash.

Data security and transaction integrity are of critical importance to businesses facilitating these transactions and to the customers. This need continues to grow as electronic transactions performed with contactless cards constitute an increasingly large share of commercial activity.

Accordingly, there is a need to provide businesses and users with an appropriate solution that overcomes current deficiencies to provide data security, authentication, and verification for contactless card.

### BRIEF DESCRIPTION OF THE SEVERAL VIEWS OF THE DRAWINGS

FIG. 1 illustrates a data transmission system in accordance with one embodiment.

FIG. 2 illustrates a contactless card in accordance with one embodiment.

FIG. 3 illustrates components of a contactless card in accordance with one embodiment.

FIG. 4 illustrates a sequence for providing authenticated access in accordance with one embodiment.

FIG. 5 illustrates a switchboard system in accordance with one embodiment.

FIG. 6 illustrates a sequence for communication with nodes of a switchboard system in accordance with one embodiment.

FIG. 7A illustrates a sequence for operations involving a contactless card and a merchant in accordance with one embodiment.

FIG. 7B illustrates a sequence for operations involving a contactless card and a merchant in accordance with one embodiment.

FIG. 7C illustrates a sequence for operations involving a contactless card and a merchant in accordance with one embodiment.

FIG. 8 illustrates a message in accordance with one embodiment.

FIG. 9 illustrates operations between an application and a server in accordance with one embodiment.

FIG. 10 illustrates operations between an application, a server, and an issuer and/or function fulfiller in accordance with one embodiment.

FIG. 11 illustrates operations between merchant devices, a switchboard network, and one or more issuer owned devices in accordance with one embodiment.

FIG. 12 illustrates a method of establishing a session and performing a function in accordance with one embodiment.

FIG. 13 illustrates distributed network authentication system in accordance with one embodiment.

FIG. 14 illustrates method performed by a distributed network authentication system in accordance with one embodiment.

FIG. 15 illustrates a computer architecture in accordance with one embodiment.

FIG. 16 illustrates a communications architecture in accordance with one embodiment.

### DETAILED DESCRIPTION

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identity, perform a payment, launch applications, log into applications, autofill a form or field, navigate to a specified web location or app on a device, unlock a door, initiate a contactless card, verify themselves, and so forth.

The systems discussed herein may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

The systems discussed herein enable merchants to advantageously process transactions and provide services across multiple devices in a distributed environment. Merchants can advantageously engage with a multiple validators, issuers, fulfillers, and payment providers through a distributed network in an efficient manner and broaden the scope of payments and services offered. The systems discussed herein provide for secure authentication and other security measures, thereby enhancing authentication, communication and network security for payments, services, and other transactions.

Further, embodiments discussed herein support tap-to mobile web experiences on both major mobile platforms (iOS®, Android®) by leveraging App Clips® and Javascript® SDK with WebNFC®. For IOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

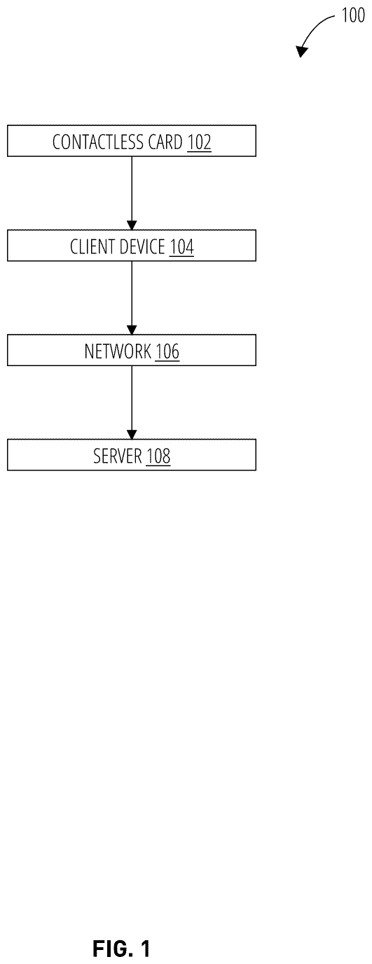

FIG. 1 illustrates a data transmission system 100 according to an example embodiment. As further discussed below, system 100 may include contactless card 102, client device 104, network 106, and server 108. Although FIG. 1 illustrates single instances of the components, system 100 may include any number of components.

System 100 may include one or more contactless cards 102, which are further explained below. In some embodiments, contactless card 102 may be in wireless communication, utilizing NFC in an example, with client device 104.

System 100 may include client device 104, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a point-of-sale (POS) terminal, a contactless card, a thin client, a fat client, an Internet browser, or other device. Client device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 104 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, client device 104 of system 100 may execute one or more applications, such as software applications, that enable, for example, network communications with one or more components of system 100 and transmit and/or receive data.

The client device 104 may be in communication with one or more server(s) 108 via one or more network(s) 106, and may operate as a respective front-end to back-end pair with server 108. The client device 104 may transmit, for example from a mobile device application executing on client device 104, one or more requests to server 108. The one or more requests may be associated with retrieving data from server 108. The server 108 may receive the one or more requests from client device 104. Based on the one or more requests from client device 104, server 108 may be configured to retrieve the requested data from one or more databases (not shown). Based on receipt of the requested data from the one or more databases, server 108 may be configured to transmit the received data to client device 104, the received data being responsive to one or more requests.

System 100 may include one or more networks 106. In some examples, network 106 may be one or more of a wireless network, a wired network or any combination of wireless network and wired network, and may be configured to connect client device 104 to server 108. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may include one or more servers 108. In some examples, server 108 may include one or more processors, which are coupled to memory. The server 108 may be configured as a central system, server or platform to control and call various data at different times to execute a plurality of workflow actions. Server 108 may be configured to connect to the one or more databases. The server 108 may be connected to at least one client device 104.

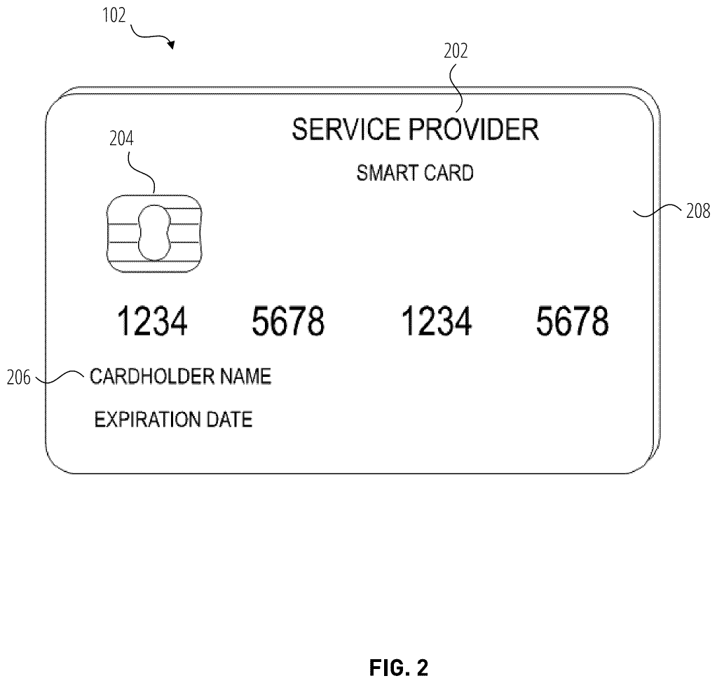

FIG. 2 illustrates an example configuration of a contactless card 102, which may include a contactless card, a payment card, such as a credit card, debit card, or gift card, issued by a service provider as displayed as service provider indicia 202 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 208, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

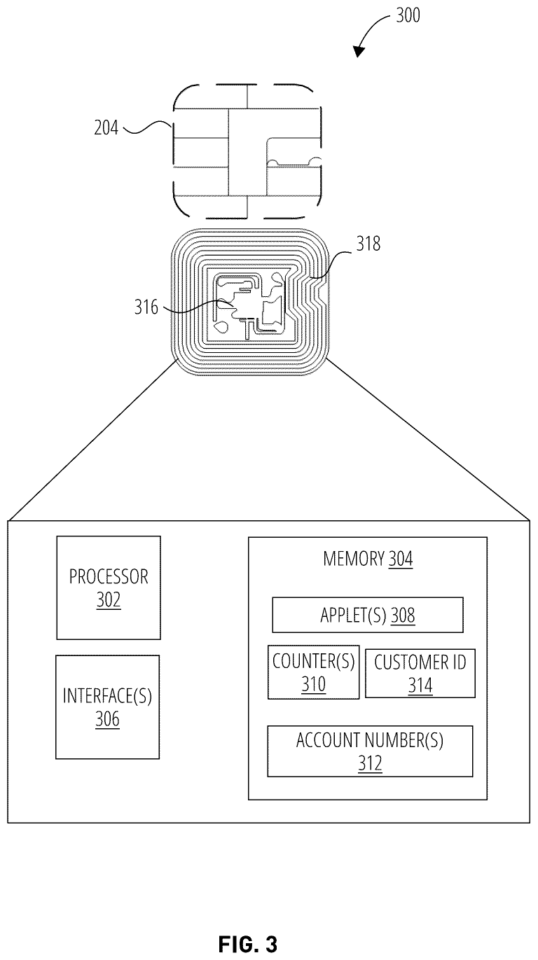

The contactless card 102 may also include identification information 206 displayed on the front and/or back of the card, and a contact pad 204. The contact pad 204 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 3. These components may be located behind the contact pad 204 or elsewhere on the substrate 208, e.g. within a different layer of the substrate 208, and may electrically and physically coupled with the contact pad 204. The contactless card 102 may also include a magnetic strip or tape, which may be located on the back of the card (not shown in FIG. 2). The contactless card 102 may also include a Near-Field Communication (NFC) device coupled with an antenna capable of communicating via the NFC protocol. Embodiments are not limited in this manner.

As illustrated in FIG. 2, the contact pad 204 of contactless card 102 may include processing circuitry 316 for storing, processing, and communicating information, including a processor 302, a memory 304, and one or more interface(s) 306. It is understood that the processing circuitry 316 may contain additional components, including processors, memories, error and parity/CRC checkers, data encoders, anticollision algorithms, controllers, command decoders, security primitives and tamperproofing hardware, as necessary to perform the functions described herein.

The memory 304 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 304 may be encrypted memory utilizing an encryption algorithm executed by the processor 302 to encrypted data.

The memory 304 may be configured to store one or more applet(s) 308, one or more counter(s) 310, a customer identifier 314, and the account number(s) 312, which may be virtual account numbers. The one or more applet(s) 308 may comprise one or more software applications configured to execute on one or more contactless cards, such as a Java® Card applet. However, it is understood that applet(s) 308 are not limited to Java Card applets, and instead may be any software application operable on contactless cards or other devices having limited memory. The one or more counter(s) 310 may comprise a numeric counter sufficient to store an integer. The customer identifier 314 may comprise a unique alphanumeric identifier assigned to a user of the contactless card 102, and the identifier may distinguish the user of the contactless card from other contactless card users. In some examples, the customer identifier 314 may identify both a customer and an account assigned to that customer and may further identify the contactless card 102 associated with the customer's account. As stated, the account number(s) 312 may include thousands of one-time use virtual account numbers associated with the contactless card 102. An applet(s) 308 of the contactless card 102 may be configured to manage the account number(s) 312 (e.g., to select an account number(s) 312, mark the selected account number(s) 312 as used, and transmit the account number(s) 312 to a mobile device or a client device 104 for autofilling by an autofilling service.

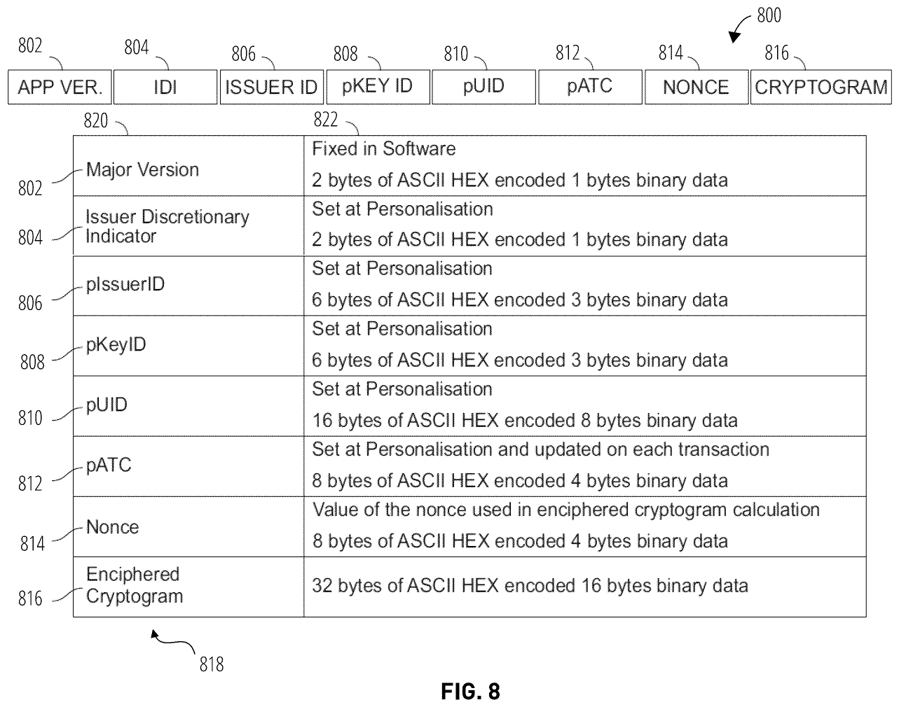

In some embodiments, the memory 304 can include (e.g., have stored therein) the data from the fields shown in FIG. 8. The processor 302 can then use the data from the fields to generate the message 800 as described herein.

The processor 302 and memory elements of the foregoing exemplary embodiments are described with reference to the contact pad 204, but the present disclosure is not limited thereto. It is understood that these elements may be implemented outside of the contact pad 204 or entirely separate from it, or as further elements in addition to processor 302 and memory 304 elements located within the contact pad 204.

In some examples, the contactless card 102 may comprise one or more antenna(s) 318. The one or more antenna(s) 318 may be placed within the contactless card 102 and around the processing circuitry 316 of the contact pad 204. For example, the one or more antenna(s) 318 may be integral with the processing circuitry 316 and the one or more antenna(s) 318 may be used with an external booster coil. As another example, the one or more antenna(s) 318 may be external to the contact pad 204 and the processing circuitry 316.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 318, processor 302, and/or the memory 304, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 308 may be added to contactless cards to provide a one-time password (OTP) for multifactor authentication (MFA) in various mobile application-based use cases. Applet(s) 308 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 308 may be configured to encode the OTP as an NDEF type 4 well known type text tag. In some examples, NDEF messages may comprise one or more records. The applet(s) 308 may be configured to add one or more static tag records in addition to the OTP record.

In some examples, the one or more applet(s) 308 may be configured to emulate an RFID tag. The RFID tag may include one or more polymorphic tags. In some examples, each time the tag is read, different cryptographic data is presented that may indicate the authenticity of the contactless card. Based on the one or more applet(s) 308, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 310 may be configured to increment. In some examples, each time data from the contactless card 102 is read (e.g., by a mobile device), the counter(s) 310 is transmitted to the server for validation and determines whether the counter(s) 310 are equal (as part of the validation) to a counter of the server.

The one or more counter(s) 310 may be configured to prevent a replay attack. For example, if a cryptogram has been obtained and replayed, that cryptogram is immediately rejected if the counter(s) 310 has been read or used or otherwise passed over. If the counter(s) 310 has not been used, it may be replayed. In some examples, the counter that is incremented on the card is different from the counter that is incremented for transactions. The contactless card 102 is unable to determine the application transaction counter(s) 310 since there is no communication between applet(s) 308 on the contactless card 102.

In some examples, the counter(s) 310 may get out of sync. In some examples, to account for accidental reads that initiate transactions, such as reading at an angle, the counter(s) 310 may increment but the application does not process the counter(s) 310. In some examples, when the client device 104 is woken up, NFC may be enabled and the client device 104 may be configured to read available tags, but no action is taken responsive to the reads.

To keep the counter(s) 310 in sync, an application, such as a background application, may be executed that would be configured to detect when the mobile client device 104 wakes up and synchronize with the server of a banking system indicating that a read that occurred due to detection to then move the counter(s) 310 forward. In other examples, Hashed One Time Password may be utilized such that a window of mis-synchronization may be accepted. For example, if within a threshold of 10, the counter(s) 310 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 310 increases in the appropriate sequence, then it possible to know that the user has done so.

The key diversification technique described herein with reference to the counter(s) 310, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

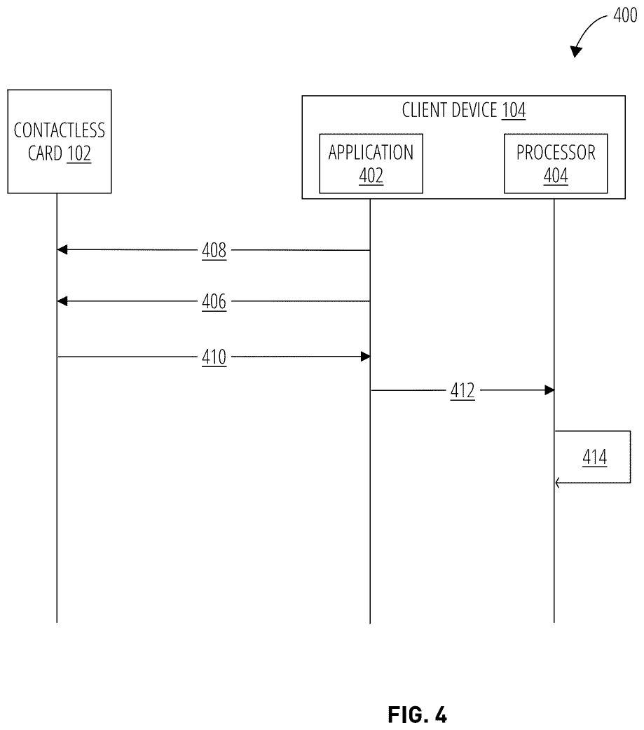

FIG. 4 is a timing diagram illustrating an example sequence for providing authenticated access according to one or more embodiments of the present disclosure. Sequence flow 400 may include contactless card 102 and client device 104, which may include an application 402 and processor 404.

At line 408, the application 402 communicates with the contactless card 102 (e.g., after being brought near the contactless card 102). Communication between the application 402 and the contactless card 102 may involve the contactless card 102 being sufficiently close to a card reader (not shown) of the client device 104 to enable NFC data transfer between the application 402 and the contactless card 102.

At line 406, after communication has been established between client device 104 and contactless card 102, contactless card 102 generates a message authentication code (MAC) cryptogram. In some examples, this may occur when the contactless card 102 is read by the application 402. In particular, this may occur upon a read, such as an NFC read, of a near field data exchange (NDEF) tag, which may be created in accordance with the NFC Data Exchange Format. For example, a reader application, such as application 402, may transmit a message, such as an applet select message, with the applet identifier (ID) of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 402 may be configured to transmit a request to contactless card 102, the request comprising an instruction to generate a MAC cryptogram.

At line 410, the contactless card 102 sends the MAC cryptogram to the application 402. In some examples, the transmission of the MAC cryptogram occurs via NFC, however, the present disclosure is not limited thereto. In other examples, this communication may occur via Bluetooth, Wi-Fi, or other means of wireless data communication. At line 412, the application 402 communicates the MAC cryptogram to the processor 404.

At line 414, the processor 404 verifies the MAC cryptogram pursuant to an instruction from the application 402. For example, the MAC cryptogram may be verified, as explained below. In some examples, verifying the MAC cryptogram may be performed by a device other than client device 104, such as a server of a banking system in data communication with the client device 104. For example, processor 404 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

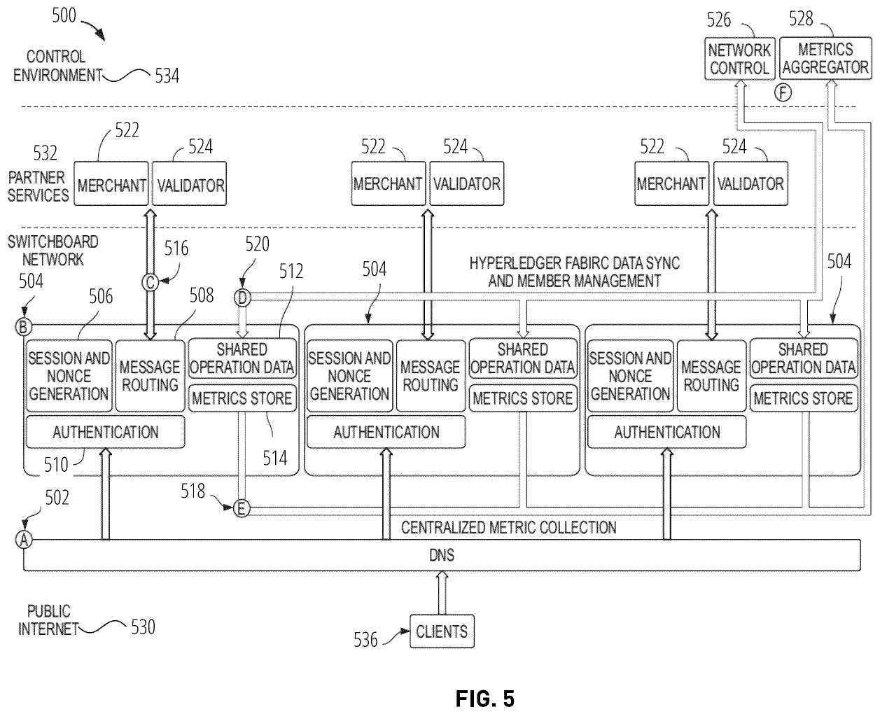

FIG. 5 illustrates an example of system 500 in accordance with the embodiments discussed herein. The system 500 includes additional devices and systems configured to enable contactless card issuers to tap-to-card services. Specifically, system 500 enables any number of issuer systems to provide card services to their clients through a switching fabric, i.e., the switchboard system in a secure and safe manner.

In embodiments, the switchboard system includes one or more nodes 504 configured to perform routing operations. Each switchboard node 504 may include a session and nonce generator 506, a message router 508, an authentication 510, an operation data 512 store, and a metrics store 514. Further, each of the nodes may be configured the same and share configurations, but each switchboard node 504 may independently process and route messages and requests to the appropriate systems, such as the merchant systems and issuer systems. Each of the nodes 504 is configured to act as a broker of trust between an issuer system, the merchant system 522, and/or validation system 524, for example. Each switchboard node 504 is configured to route each message to the correct issuer system while maintaining data security. For example, a switchboard node 504 may route a message between an issuer system and a merchant system while the node cannot access the private data in the message.

The switchboard system 500 may be configured as a server system with a collection of hardware, software, and networking components that work together to provide client services. Hardware components may include one or more server computers, storage devices, and network adapters. The server computers are configured to run server applications, such as those executable on each of the nodes 504. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

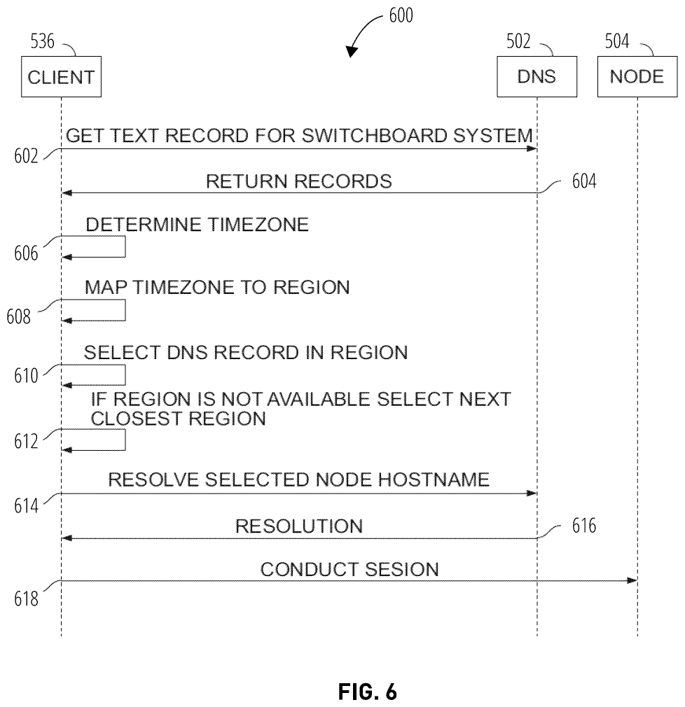

In some embodiments, the nodes 504 may operate in a cloud-based computing environment, e.g., a collection of hardware, software, and networking components that enable the delivery of cloud computing services. The switchboard nodes 504 and the computing services are delivered over the Internet and can be accessed from anywhere in the world with an Internet connection. In embodiments, client 536 may access a switchboard node 504 through DNS 502 or Domain Name System (DNS). The DNS 502 is a hierarchical and distributed naming system for computers, services, and other resources connected to the Internet or other networks. It associates various information with domain names assigned to each registered participant. In one example, the DNS 502 may translate a name known to software executing on a client 536 to route data to one or more of switchboard node 504 of the switchboard system. In embodiments, the DNS 502 may generate a number, such as an Internet Protocol (IP) address, an address record (A-record), or another Hostname (C-name record). FIG. 6 illustrates one example sequence 600 for a client to identify and resolve an identifier for one of the nodes 504 of the switchboard system. At a high level, the DNS 502 translates known domain names to numerical Internet Protocol (IP) addresses needed for locating and identifying computer services and devices with the underlying network protocols. Clients use the global DNS system to select the best node to use, as discussed in sequence 600.

In embodiments, a client 536 communicates with the switchboard system to perform one or more of the partner services 532, such as conducting a transaction with a merchant, validating the customer, or other tap-to functions. Once client 536 identifies a switchboard node 504 and resolves an address to communicate with switchboard node 504, client 536 may send one or more messages to switchboard node 504 to authenticate and perform the operation. The switchboard node 504 includes an authentication 510 function that is configured to authenticate the client 536. In embodiments, the client 536 sends a message or authorization request to the switchboard node 504 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65535 | Client ID | Individual identifier of client |
| GReyx5BuEAaE72bWbFZHHRLsDbt1Uum | Client Key | Randomly assigned key |

The switchboard node 504 may authorize or authenticate the client 536 or user, and the switchboard node 504 may utilize the additional components, such as the session and nonce session and node generator 506 and message router 508, to perform the operations. Note the validation systems validation system 524 never interact with the merchant systems 522, nor vice versa. The nodes node 504 brokers all communication.

In embodiments, the switchboard system may utilize a hyper ledger fabric 520 to manage to synchronize the shared operation data 512 and member management across the network. The hyperledger fabric 520 is distributed ledger framework having a permissioned network model that only authorized participants can join the network and access the data that is stored on a ledger.

In embodiments, the hyperledger fabric 520 may be generated by creating one or more sets of peers, an ordering service, and a channel. Once the network is created, system 500 deploys chaincode to the network, or node 504 is permitted to access the fabric. The chaincode is the code that runs on the blockchain and executes the network control 526 and operation data 512 logic code. Once the chaincode is deployed, each of the switchboard nodes 504 is configured to invoke transactions on the blockchain to add data to the blockchain, e.g., the operational data. A switchboard node 504 or another device can query the ledger to retrieve data. The ledger is a distributed database that stores all the data added to the blockchain.

All nodes 504 keep an independently verifiable log of their actions that can be transmitted to a centralized aggregator to build a picture of overall network usage. System 500 can manage network operation data and management at a central level and have a centralized view of network use, aggregated and abstracted to the appropriate level.

FIG. 6 illustrates an example sequence 600 for a client to utilize DNS to resolve and communicate with one or more nodes of a switchboard system. The illustrated sequence 600 includes a client 536, a DNS 502, and a switchboard node 504. At 602, the sequence 602 includes the client 536 sending a request to a default DNS server for a text record switchboard. {domain}. {tld}. The text record may be preconfigured in a client app and/or client SDK. At 604, the DNS 502 returns one or more records. A DNS record structure may include the following:
Root Record:
   Name: switchboard. {domain}. {tld}
   Type: TXT
   Resolution:
      {nodename_1}.{operator_a}.{region_i}.switchboard.{domain}.{tld},
      {nodename_2}.{operator_a}.{region_i}.switchboard.{domain}.{tld},
      {nodename_1}.{operator_b}.{region_ii}.switchboard.{domain}.{tld},
      {nodename_2}.{operator_b}.{region_ii}.switchboard.{domain}.{tld},
      * etc.
   Used For determining where there are active nodes
Node Record:
   Name: {nodename}. {operator}. {region}.switchboard. {domain}. {tld}
   Type: A/AAAA or CNAME
   Resolution: Actual node hostname or IP
   Used For: communicating with a node 504

In embodiments, the client 536 may determine the current timezone at 606. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. At 608, the client 536 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 610, the client 536 may identify or select a DNS record option returned at 604 that is in the region. If there are multiple matches, the client 536 may select one at random. If there's no node available in a region, the client 536 may determine and use a data graph of neighboring regions to select a node in the closest region where a node is available at 612. For example, sa has no node but is connected to na-e where there is a node and so na-e is selected. In some embodiments,

At 614, the client may resolve a selected node's hostname. In embodiments, the client 536 may automatically resolve the hostname using the client's HTTP request default resolver. At 616, the DNS 502 may return a result. And at 618, the client 536 may communicate with a switchboard node 504 and begin the process to interact with the switchboard.

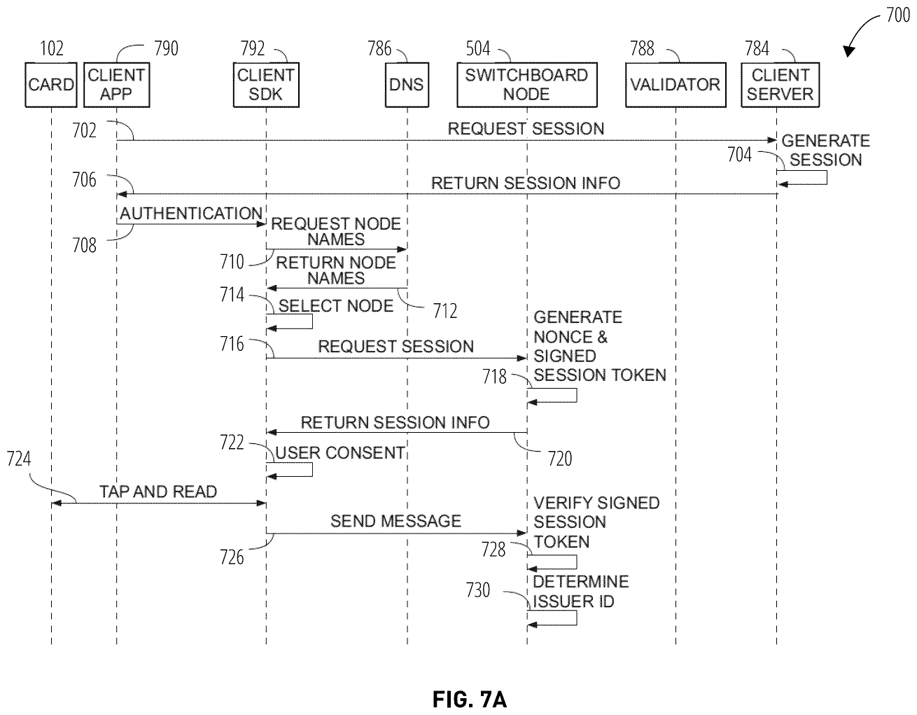

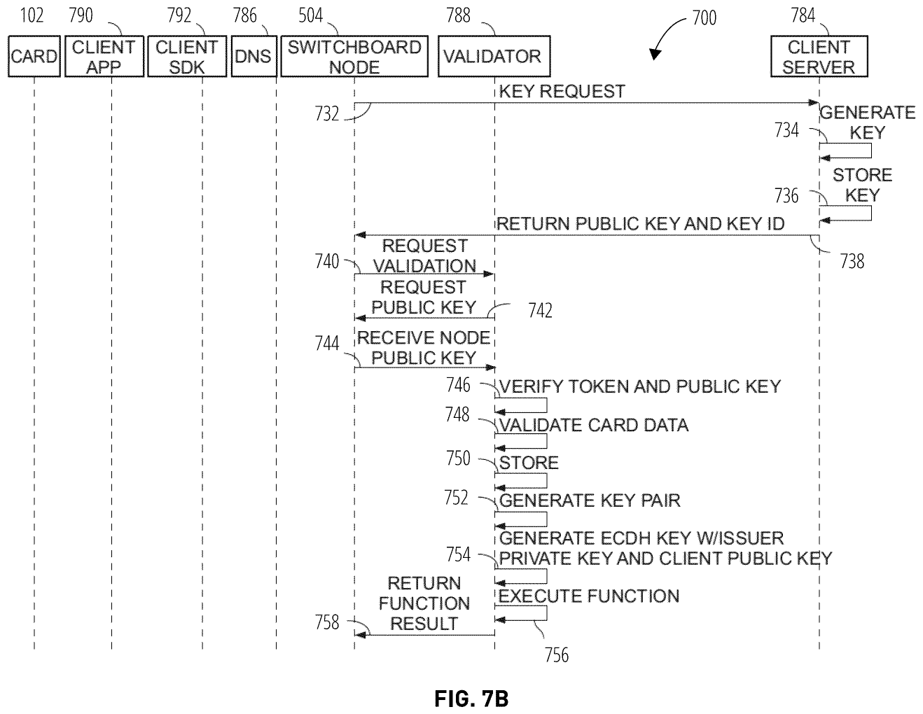

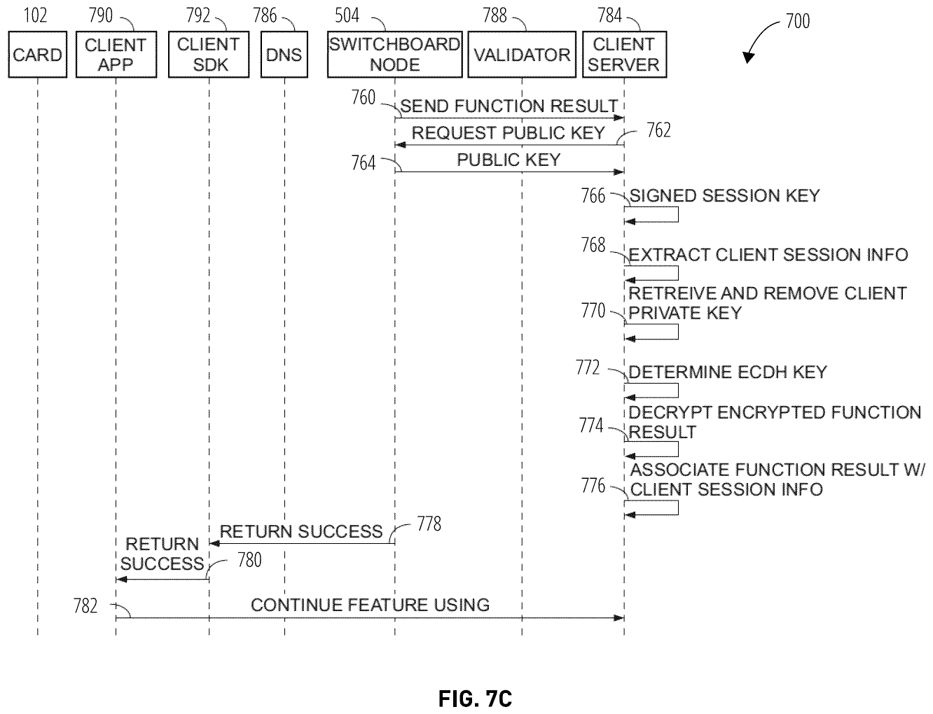

FIG. 7A-FIG. 7C illustrate an example sequence 700 to perform operations between a contactless card and services provided by a card issuer and/or merchant. The illustrated sequence 700 includes actions and communications performed by a contactless card 102, a client 536 including a client app 790 and a client SDK 792, a DNS 786, a switchboard system including one or more nodes 504, a partner services 532 including a merchant and/or validator 788, and control services 534 including a client server 784 or system. In embodiments, the client app 790 may be any application configured to execute on a client 536, such as a banking app, a merchant app, a social media app, a travel app, a gaming app, a productivity app, an entertainment app, and so forth. In embodiments, the client app 790 includes a web browser to provide websites and pages. The client app 790 may include and/or utilize the client SDK 792, which may be a set of instructions that enable the client app 790 to communicate with other components of the switchboard system.

In embodiments, as shown in FIG. 7A, at 702 the client 536 including the client app may send a request and establish a session with a client server 784 such that a result may be associated with the correct client device or user. The request establishes a relationship between the client device and client server, which may be an issuer server. At 704, the client server 784 generates a session and CLIENT SESSION INFORMATION. At 706, the client server 784 returns the session information, e.g., the CLIENT SESSION INFORMATION. In embodiments, the CLIENT SESSION INFORMATION may be the Client implementation-specific user session identification information.

At 708, the client 536 may initiate a contactless card authentication process with the client 536. For example, the client 536 may call a function and/or pass information to the client 536 to initiate authentication via a contactless card 102. At 710-714, the client 536 may utilize DNS to identify a node and establish communication with the node. Specifically, at 710, the client 536 including the client SDK 792 may send a request for switchboard hostnames, and at 712 the the DNS 786 may return information including one or more hostnames. At 714, the client 536 may determine a switchboard node to communicate. FIG. 6 illustrates an example of a more detailed sequence of the process to establish communication with a switchboard node 504.

At 716, the client 536 may send a request for a session to the switchboard system 500. In embodiments, the request for a session may be for a function request in the format <FUNCTION REQUEST>. In embodiments, the FUNCTION REQUEST may be the data/function that the client 536 would like to request once a contactless card 102 has been validated. The function could be for any service discussed herein, e.g., authenticate the user, perform a transaction, request autofill data, etc. At 718, switchboard system 500 may generate a nonce and a signed session token. The signed session token may be a JavaScript Object Notation (JSON) Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 102. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST>signed with <NODE PRIVATE KEY>, where the NODE PRIVATE KEY is the switchboard system 500 private key. The switchboard system 500 may include a NODE PUBLIC/PRIVATE KEY, which is a keypair used to sign and validate JWTs.

At 720, the switchboard system 500 may return session information to the client 536. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 722, the client SDK 792 may determine and/or receive user consent to the terms of service. In one example, the client SDK 792 captures and records the user consent to <FUNCTION TOS> on <CONSENT DATE> with <TOS VERSION>. The CONSENT DATE may be the timestamp for the user's consent to the TOS.

At 724, the client 536 exchanges one or more messages with a contactless card. In one example, the exchange may be based on the contactless card being tapped to a client device. In embodiments, the client SDK 792 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message Tag | D1 (only record) |
| 01 | Length of Record | 01 |
| | Type | |
| 02 | Length of Record | 33 |
| 03 | text record type | 54 |
| 04 | Length of Language | 02 |
| 05-06 | Language | 65 6E (“en”) |
| 07 . . . 0E | NONCE | 8 bytes of ASCII HEX encoded 4 bytes binary data |
| 0F . . . 12 | Session Indicators | 4 bytes of ASCII HEX encoded 2 bytes binary data |
| 13 . . . 16 | Control Indicators | 4 bytes of ASCII HEX encoded 2 bytes binary data |
| 17 . . . 26 | Update Date | 16 bytes of ASCII HEX encoded 8 bytes binary data - |
| | creation Time | represents 64 bit unix timestamp |
| 27 . . . 36 | Update MAC | MAC to protect control indicators - 16 bytes of ASCII |
| | | HEX encoded 8 bytes binary data |

The updated MAC may be calculated to protect the control indicators in embodiments. Specifically, The MAC M is determined by calculating a MAC over the 10 bytes of the update data U with the Update MAC Card Key (MCK), as described in FIG. 8, message 800.

At 724, the contactless card may generate and provide a message to the client's device including the client SDK 792. The data in the message may be utilized by the system discussed herein to perform the function requested. One example of the message is illustrated and discussed in FIG. 8, message 800.

At 726, the client including the client SDK 792 may send a message and information to the switchboard system 500. The message may be the message received from the contactless card 102, e.g., message 800. In addition, the client SDK 792 may send the consent date, the TOS version, and the signed session token to the switchboard system 500. The switchboard system 500 may utilize the information to ensure the session is valid. At 728, the switchboard system 500 verifies the signed session token is valid, e.g., is the previously provided signed session token and includes the nonce previously generated and is in the message.

In some embodiments, the switchboard system 500 is configured to determine which issuer system or client-server it should route the message to for processing. At 730, the switchboard system 500 may determine the issuer ID by extracting it from the message received from the contactless card 102 via the client SDK 792. As mentioned, the issuer ID identifies the issuer of the contactless card 102.

FIG. 7B continues the sequence 700 from FIG. 7A. In embodiments, the switchboard system 500 is configured to generate and communicate secure communications with the issuer system, e.g., the client server 784 and the validator 788. At 732, the switchboard system 500 sends a request for a key to the client server 784. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 734, the client server 784 generates a portion of the key. In some instances, the client server 784 may generate half of the ECDH key for encryption/decryption of PII. Specifically, the client server 784 may generate <CLIENT EC PUBLIC KEY> and <CLIENT EC PRIVATE KEY>using Elliptic Curve P256. The CLIENT EC PUBLIC KEY AND CLIENT EC PRIVATE KEY is the first half of the ECDH key negotiation.

At 736, the client-server 784 stores the generated portion of the key in storage. Specifically, the client server 784 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 784 may return the public key portion to the switchboard system 500 with the KEY ID at 738. The switchboard system 500 may store the public key portion with the KEY ID for later use, e.g., generation of the ECDH key. At 740, the switchboard system 500 may request a validation to be performed by the validator 788. In one example, the switchboard system 500 may send a request validation as Request validation <MESSAGE>, <SIGNED SESSION TOKEN>, <CLIENT EC PUBLIC KEY>, <CONSENT DATE>, and the <TOS VERSION>. The validator 788 may make an out-of-band request back to the switchboard system 500 for the public key to verify the session at 742. At 744, the switchboard system 500 may provide the node's public key, i.e., <NODE PUBLIC KEY>. Further at 746, the validator 788 may utilize the node's public key to verify the secure session token.

In embodiments, the validator 788 may validate the message at 748. In embodiments, the validator 788 may perform a number of validations including ensuring the nonce in the message is correct along with additional information, such as the card's unique identifier (pUID), and the counter value (pATC). Additional details of a validation process that may be performed are described herein.

At 750, the validator 788 may store information associated with the session. For example, validator 788 may store the <CONSENT DATE> with the <TOS VERSION> and the <PUID>. The validator 788 may also generate another portion of the key, e.g., the ECDH key. For example, the 788 may Generate <ISSUER EC PUBLIC KEY> and <ISSUER EC PRIVATE KEY>using Elliptic Curve P256. The ISSUER EC PUBLIC KEY and ISSUER EC PRIVATE KEY may be the second half of the ECDH key negotiation.

At 754, the validator 788 may generate the complete ECDH key. For example, the validator 788 generates the <ECDH KEY> from <ISSUER EC PRIVATE KEY> and <CLIENT EC PUBLIC KEY>. The ECDH KEY is the final key generated using ECDH key negotiation.

The validator 788 may utilize the ECDH KEY to encrypt data for the function. For example, if the validator 788 validates the message in some instances, the validator 788 may execute a function request to create a function result and encrypt the result with the ECDH KEY at 756. For example, the validator 788 may Execute <FUNCTION REQUEST> to create <FUNCTION RESULT> and encrypt it with the <ECDH KEY>. The function result may be any result based on the requested function, e.g., verification of the card.

At 758, the validator 788 may return the function result to the switchboard system 500. In some instances, the function result is returned encrypted. For example, the validator 788 may return the <ENCRYPTED FUNCTION RESULT> and the <ISSUER EC PUBLIC KEY>.

FIG. 7C continues the sequence 700 from FIG. 7B. In embodiments, at 760 the switchboard system 500 sends the function result to the client server 784 to process the result. In one example, the switchboard system 500 may send the <ENCRYPTED FUNCTION RESULT>, <KEY ID>, <ISSUER EC PUBLIC KEY>, and <SIGNED SESSION TOKEN>. At 762 and 764, the client server 784 may make a request for and receive the public key from the switchboard system 500. In some instances, the exchange may be performed via out-of-band communication channels. The public key for the node may be <NODE PUBLIC KEY>. The public key may be used to verify the sender of the function result, etc. At 766, the client server 784 may verify the signed session key with the node's public key <NODE PUBLIC KEY> to verify the sender of the information. At 768, the client server 784 may extract client information from the signed session token. For example, the client server 784 may Extract <CLIENT SESSION INFO> from <SIGNED SESSION TOKEN>, i.e., extracting the client implementation-specific user session identification information.

Further, at 770, the client server 784 may retrieve the client's private key with the KEY ID. Specifically, the client server 784 may get and remove the <CLIENT PRIVATE KEY> from cache using the <KEY ID>. At 772, the client server 784 may generate or compute the ECDH key. For example, the client server 784 may compute the <ECDH KEY> with the <CLIENT PRIVATE KEY>+<ISSUER EC PUBLIC KEY>. The client server 784 may decrypt the function result with the computed key at 774. Specifically, the client server 784 may decrypt the <ENCRYPTED FUNCTION RESULT> with the <ECDH KEY> to determine the <FUNCTION RESULT>. At 776, the client server 784 associates the function result with the session.

In embodiments, the switchboard system 508 may return whether the function result was successfully completed or not at 778 to the client SDK 792. Further at 780, the client SDK 792 may notify the client app 790 of the result. At 782, the client app 790 may utilize the feature. For example, the 782 may communicate with the client server 784 to continue the feature using the <CLIENT SESSION INFO> to fetch the redacted <FUNCTION RESULT>.

FIG. 8 illustrates an example of a message 800 that may be communicated by a contactless card to perform the functions described herein, such as those discussed in FIG. 7A through FIG. 7C. One or more of the fields in message 800 may also be utilized to route the message 800 through the switchboard system and perform authentication/validation techniques.

In embodiments, the message 800 includes an applet version 802 field, an issuer discretionary indicator 804 field, an Issuer Identifier 806 field, a pKey ID 808 field, a pUID 810 field, a pATC 812 field, a nonce 814 field, and an encrypted cryptogram 816.

In embodiments, the fields may be in plain text or encrypted. For example, the applet version 802 field may include an applet version in plain text. The applet version indicates which applet version is installed on a contactless card and may be used by the other systems to determine how to process the message 800 when communicated. For example, different Applet versions require different validation logic, e.g., an older message may be routed through the issuer system to perform various operations for validation, while a newer message may be routed through the switchboard system to perform the various operations, including validation.

In embodiments, the message 800 includes an issuer discretionary indicator 804 field that may include issuer data and set at the time of personalization. In addition, the message 800 includes an Issuer Identifier 806 field that may include a unique ID assigned to the entity issuing the card, e.g., the issuer. For example, when joining the system, each issuer may be assigned a unique identifier during an onboarding operation. The issuer ID can be used by the switchboard system 508 to route a message and its contents to the appropriate services that are associated with that particular issuer.

In embodiments, the message 800 includes a pKey ID 808 field. In some instances, the pKey ID 808 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described herein.

The message 800 may include a pUID 810 field, including a card unique identifier assigned to the contactless card at personalization time. The pUID 810 field data may be a combination of alphanumeric characters used to identify each card and associated with a user uniquely.

In embodiments, the message 800 includes a pATC 812 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 800 is created, a new session key is derived and utilized to generate one or more portions of the message 800. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 800 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 102 and a device via wired means, e.g., via the contact pad, and in accordance with the EMV protocol.

As discussed above, the contactless card 102 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 102. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 102 stores the generated application key(s) or UDK(s).

In embodiments, the contactless card 102 utilizes the application key(s) or UDK(s) to generate session keys for each encrypted data is generated. The following is one processing flow that may be performed by the contactless to generate a unique cryptogram session key (ASK).

To generate the ASK, the contactless card 102 computes SKL by encrypting [ATC[2]∥ATC[3]∥‘F0’∥‘00’∥[ATC[0]∥[ATC[1]∥[ATC[2]∥[ATC[3]] with an application key. Further, the contactless card 102 computes SKR by encrypting [ATC[2]∥ATC[3]∥‘0F’∥‘00’∥[ATC[0]∥[ATC[1]∥[ATC[2]∥[ATC[3]] with the application key. Finally, the contactless card 102 concatenates SKL with SKR to form an authentication session key (ASK). In embodiments, the ASK is used to perform operations utilizing the contactless card 102, such as encrypting the cryptographic MAC.

In embodiments, the contactless card 102 also supports session key derivation to generate a unique encipherment session key DESK. The contactless card 102 computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card 102 computes SKR by encrypting [ATC[2]∥ATC[3]∥‘0F’∥‘00’∥‘00’∥‘00’∥‘00’∥‘00’] with the DEK or UDK. The contactless card 102 concatenates SKL with SKR to form the Data Encipherment Session Key (DESK).

In embodiments, the contactless card 102 generates encrypted data or a cryptogram utilizing the session keys. Specifically, the contactless card 102 generates a cryptogram C by calculating a MAC over the 32-byte transaction data T using the Authentication Session Key (ASK).

The contactless card 102 may process the data to generate the cryptogram. Specifically, the contactless card 102 divides T into four blocks of 8 bytes of data: T=T1∥T2∥T3∥T4. The contactless card 102 computes B=DES(ASKL)[T1], where is the Data Encryption Standard or another symmetric encryption algorithm, ASKL is a portion of the ASK, e.g., the “left” half of the key. The contactless card 102 computes B=[B XOR T2], and, the contactless card 102 computes B=DES(ASKL) [B], where DES is an encryption algorithm. The contactless card 102 computes B=[B XOR T3], and the contactless card 102 computes B=DES(ASKL) [B]. The contactless card 102 computes B=[B XOR T4], and the contactless card 102 computes B=DES(ASKL) [B]. The contactless card 102 computes B=DES-1 (ASKR) [B], where DES-1 is the reciprocal DES operation, and ASKR is a portion of the ASK, e.g., the right half. The contactless card 102 computes the cryptogram C=DES(ASKL) [B].

In embodiments, a contactless card 102 may also encipher the cryptogram to secure the data further. For example, a contactless card 102 may generate an 8-byte random number [RND] and the card computes E1=DES3 (DESK) [RND], where DES3 is a symmetric encryption algorithm such as the Triple Data Encryption Standard. The contactless card 102 then computes B=[E1] XOR [C], where C is the cryptogram generated, as discussed above. The contactless card 102 computes E2=DES3 (DESK) [B], where B is computed above. Further, the contactless card 102 generates the 16-byte enciphered payload E=[E1]∥[E2].

In embodiments, a device or the contactless card 102 may decrypt the payload E by determining, receiving, or retrieving the payload E. The device computes a RND=DES3-1 (DESK) [E1]. The device determines B=DES3⁻¹ (DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 102 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U =U₁∥U₂. Further, operations may be performed on U₁ and U₂.

Embodiments include applying an algorithm to the first portion (U₁) of the data. In one example, a result B may be computed where B=DES (MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

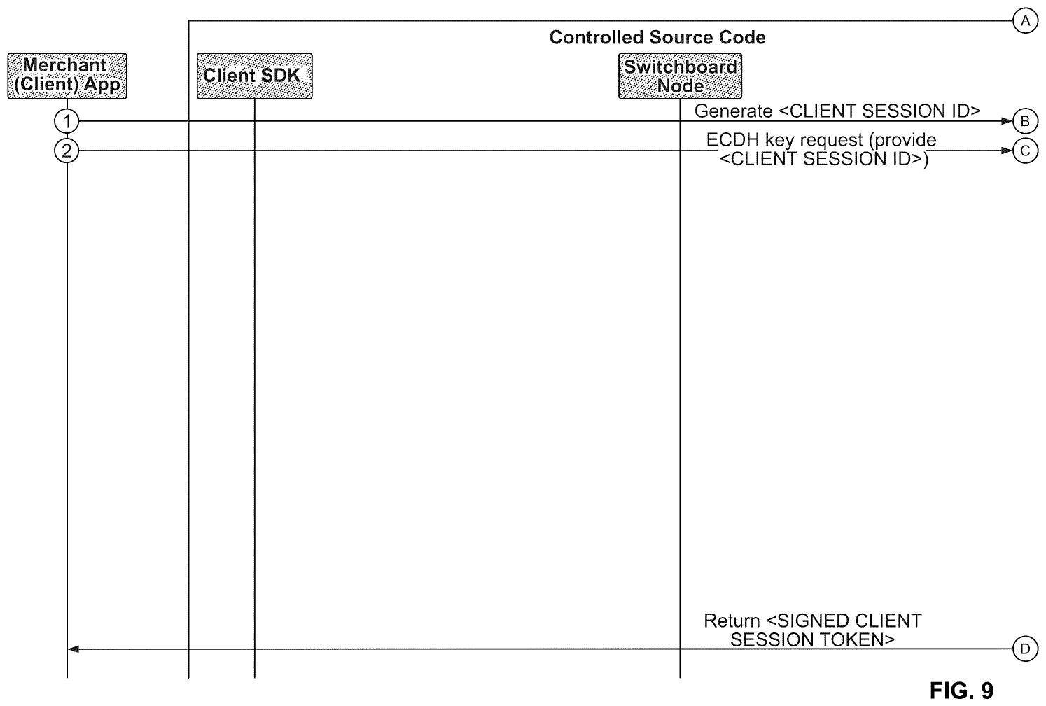

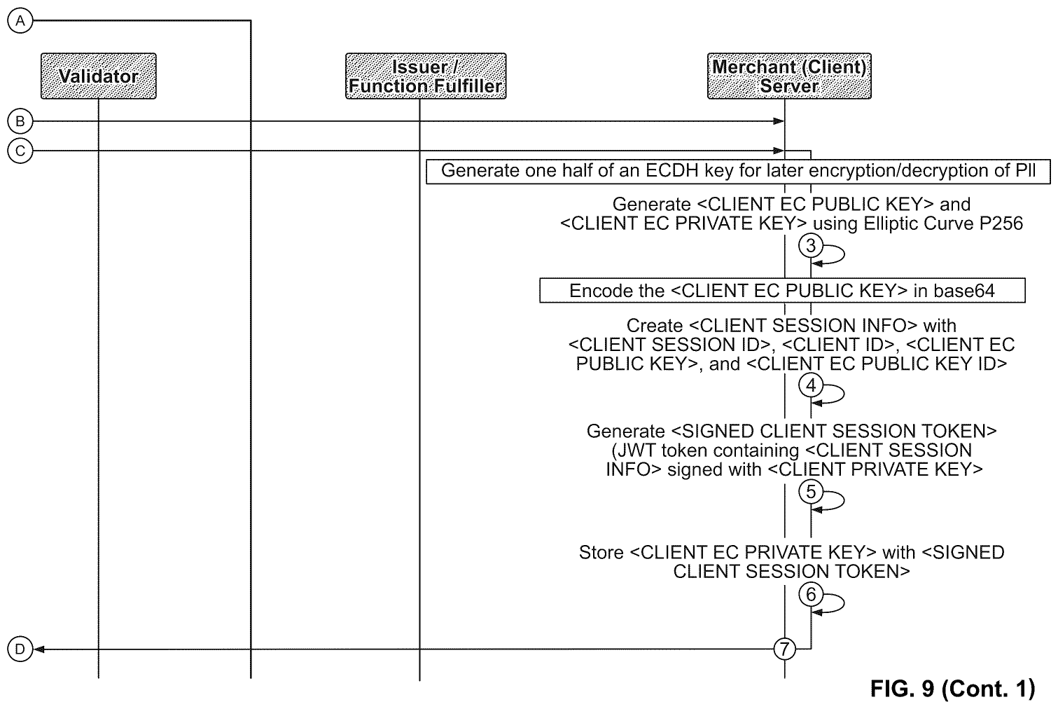

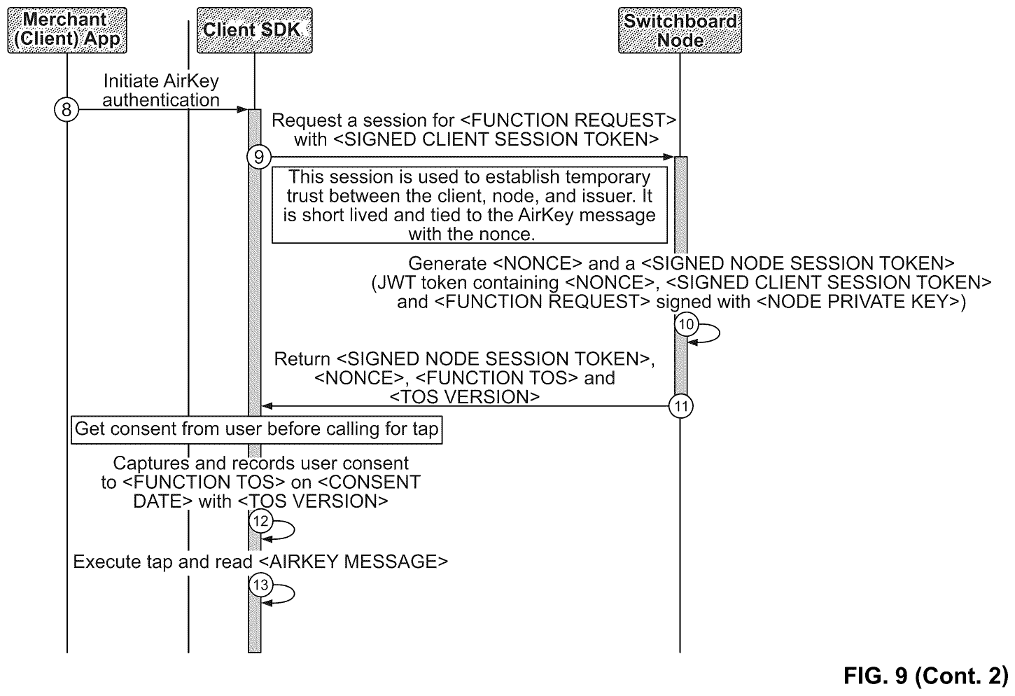

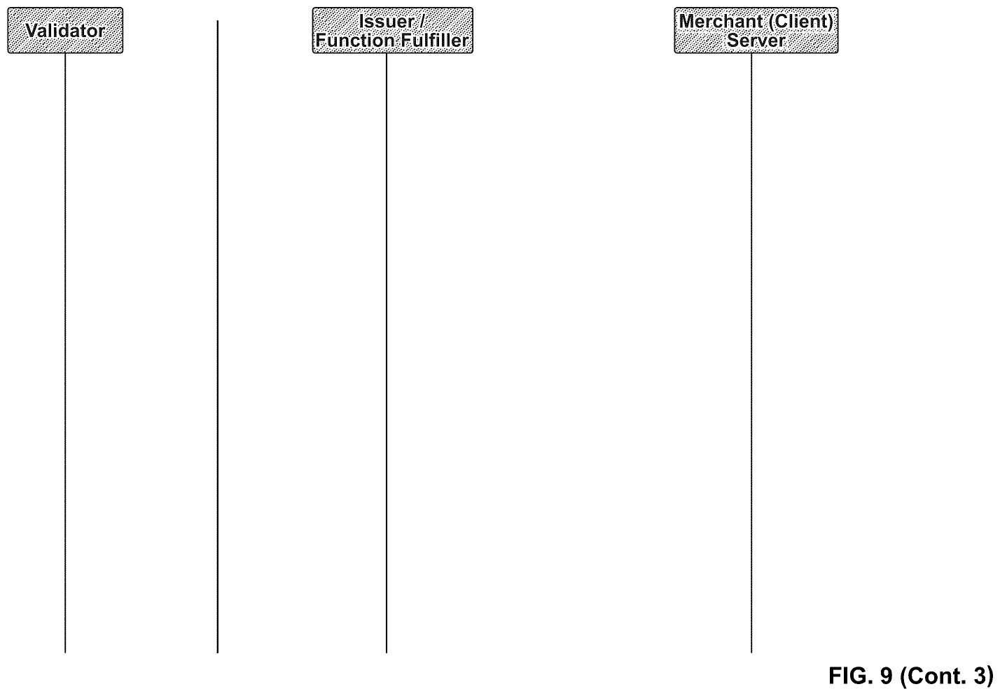

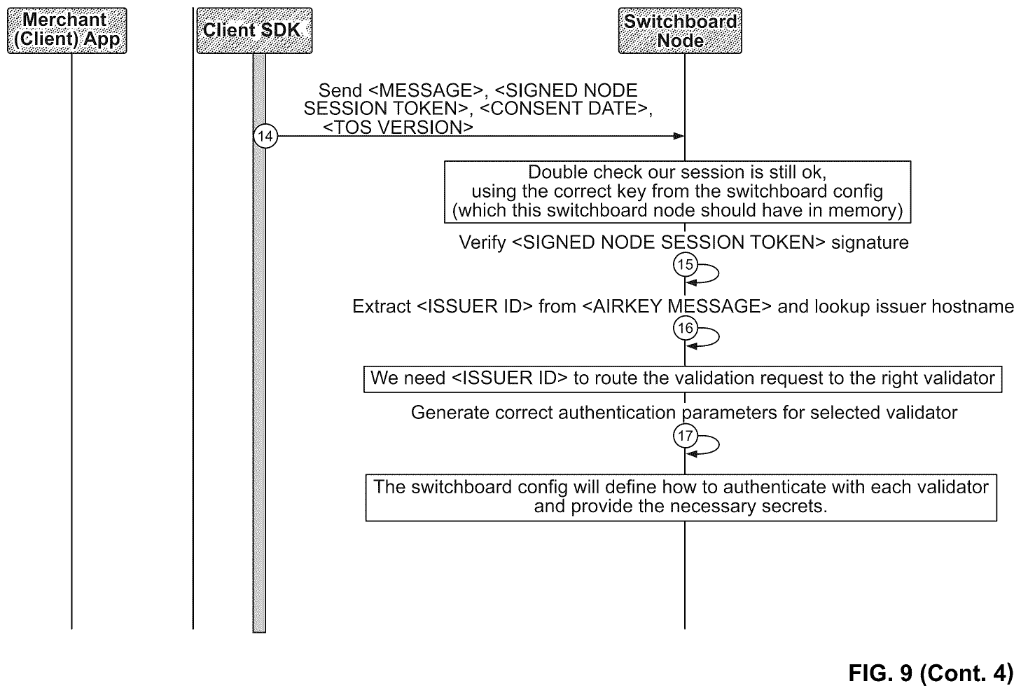

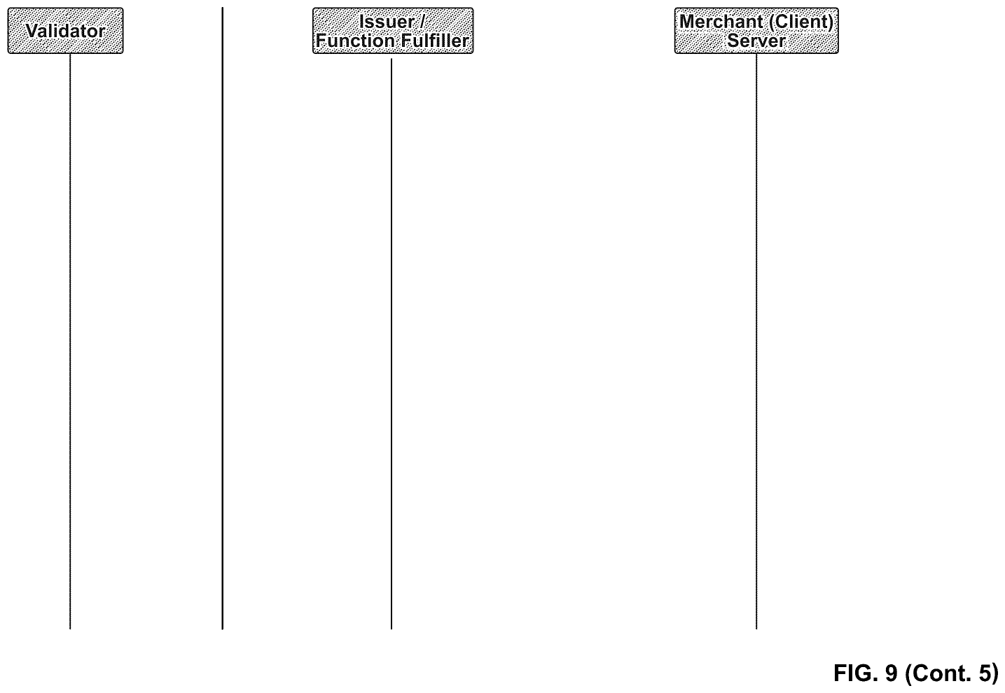

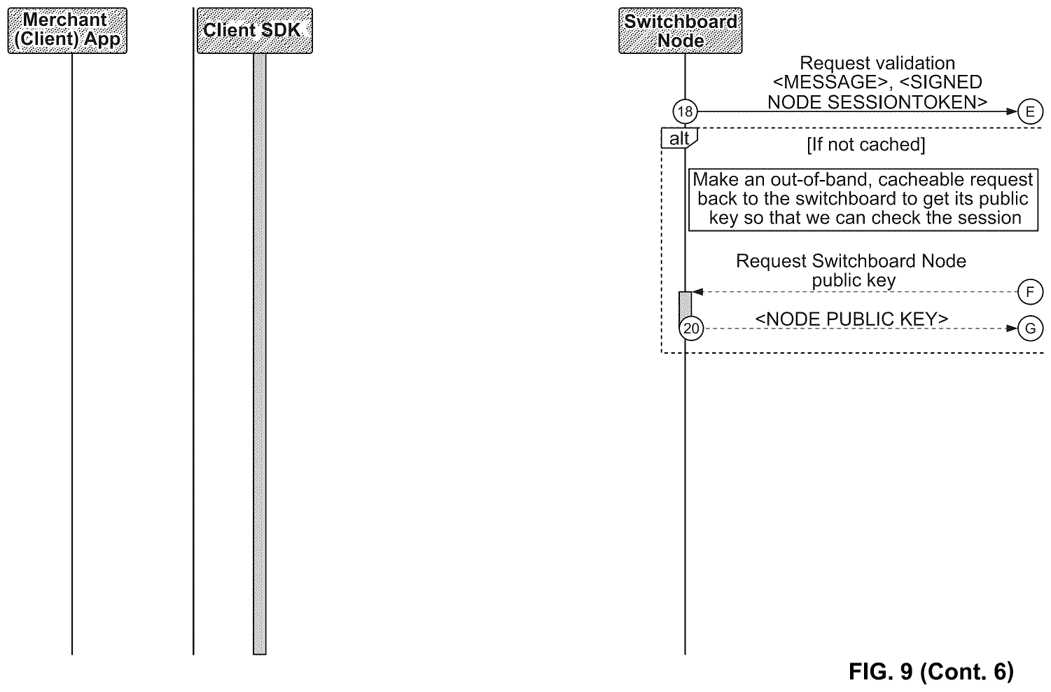

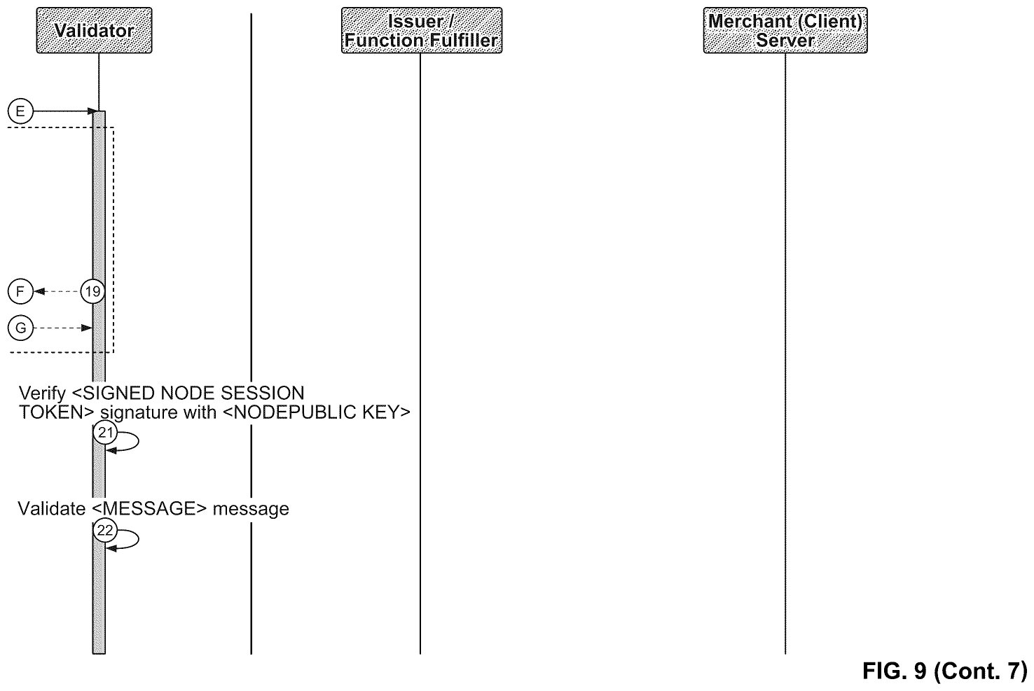

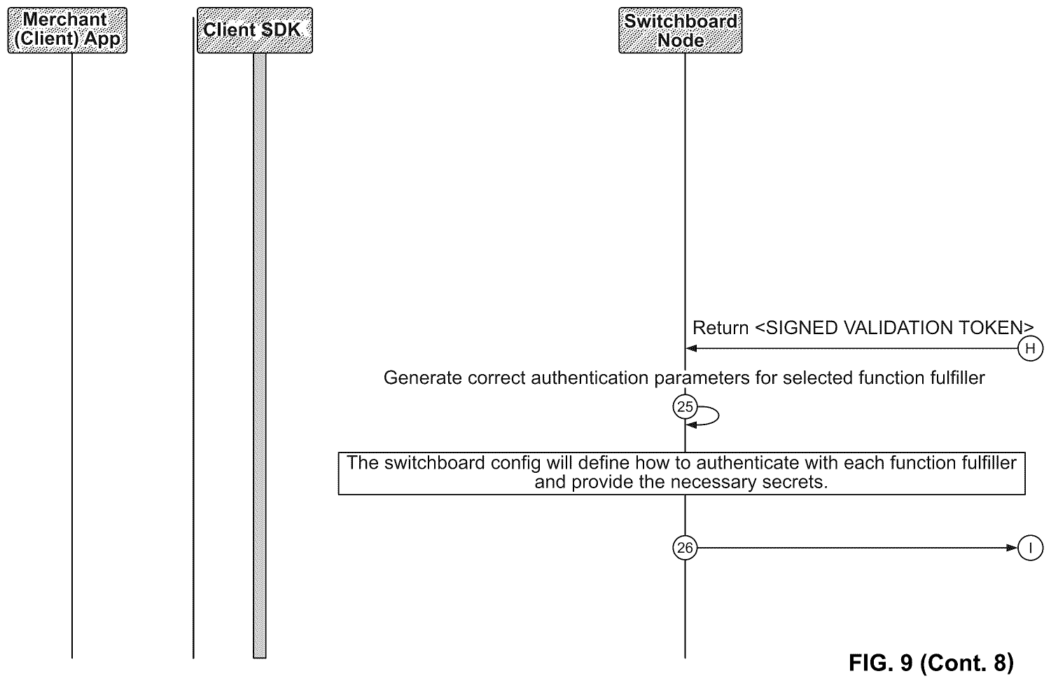

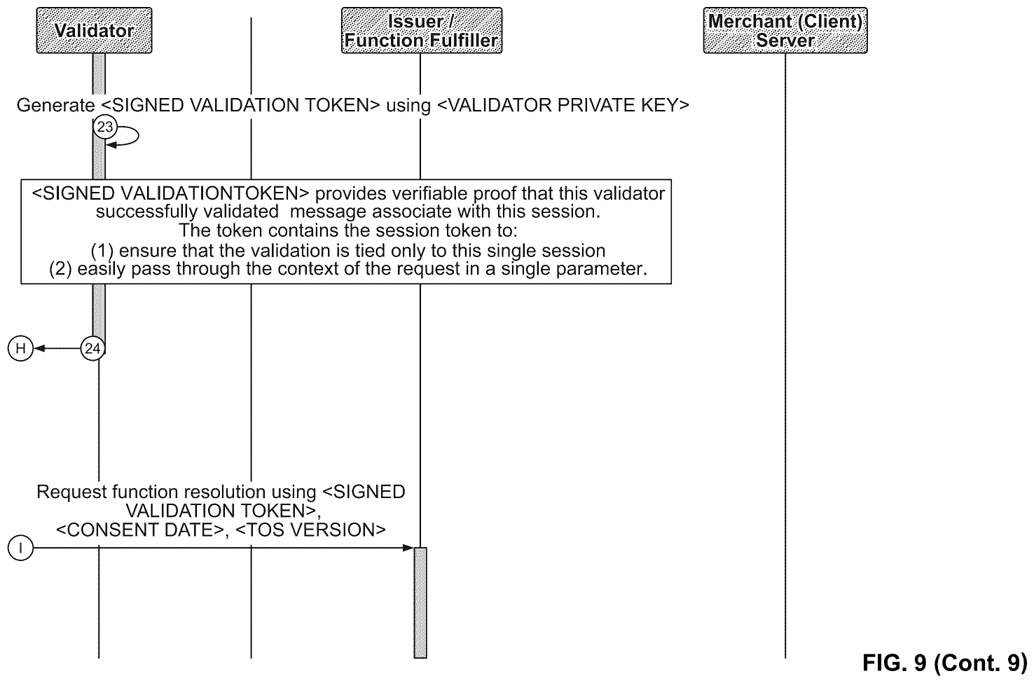

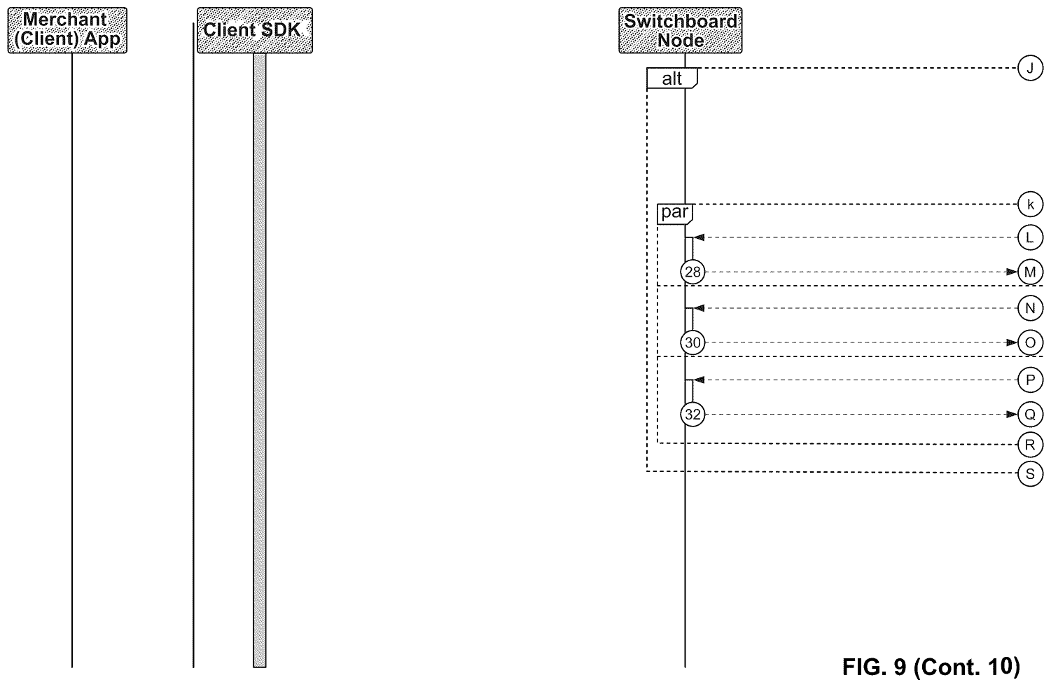

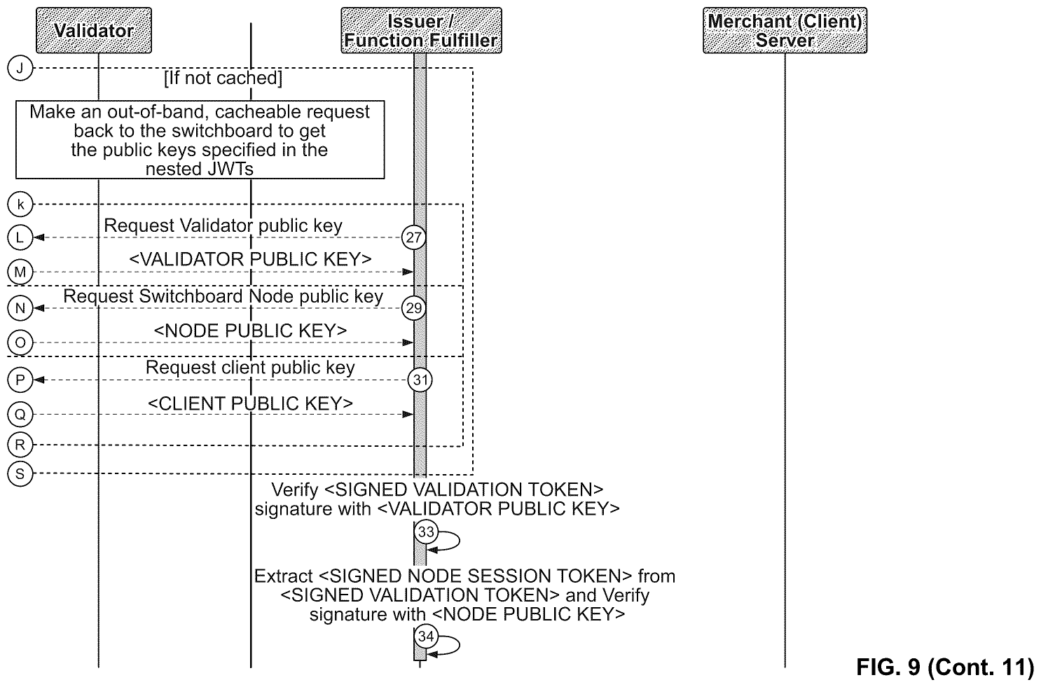

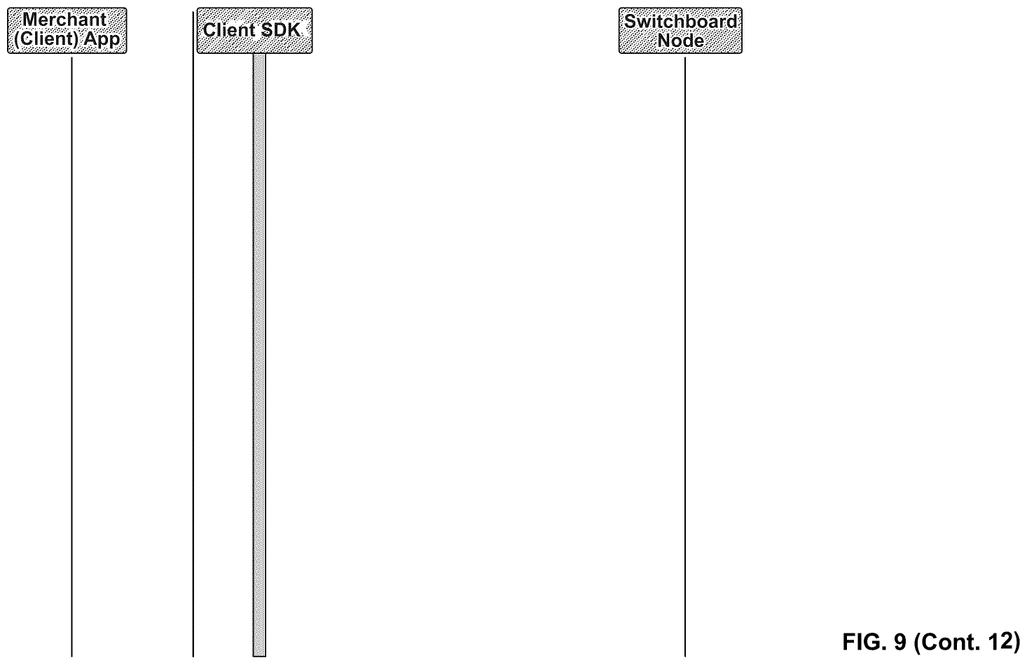

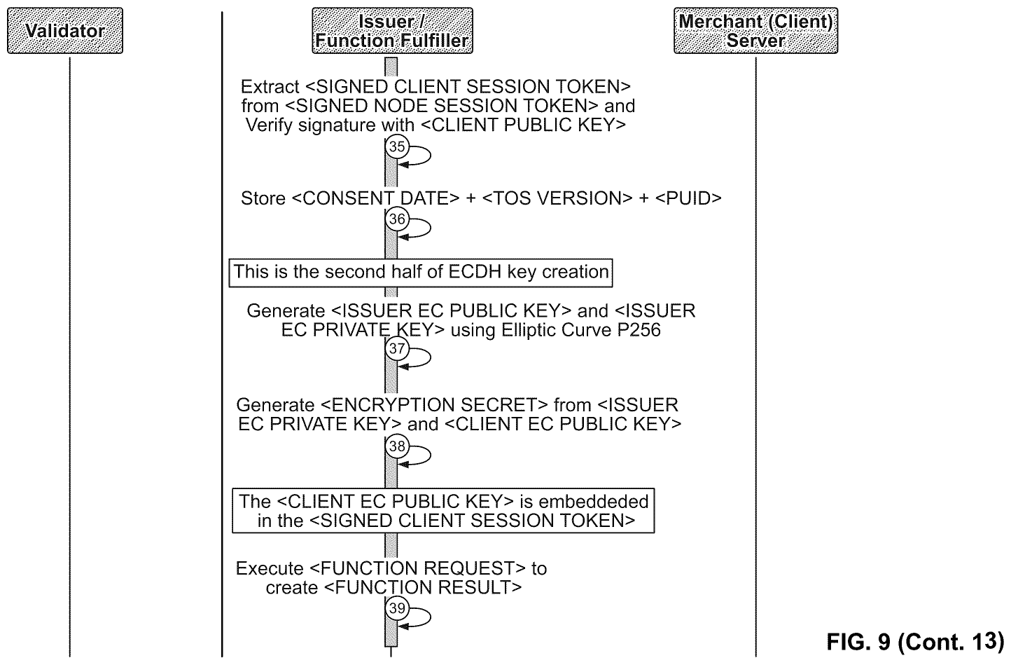

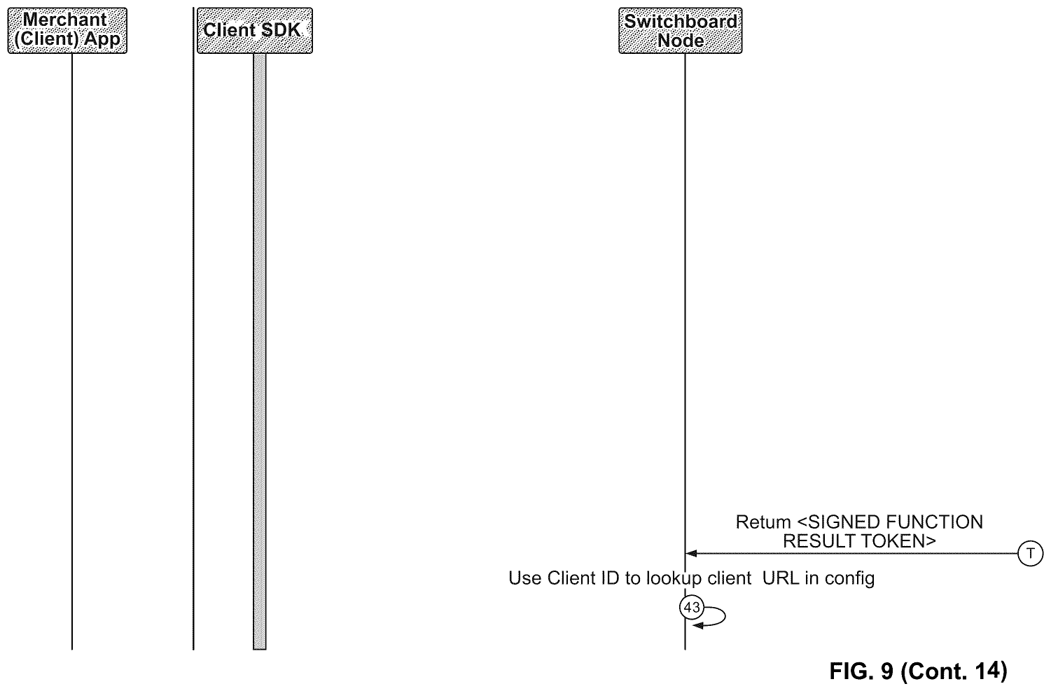

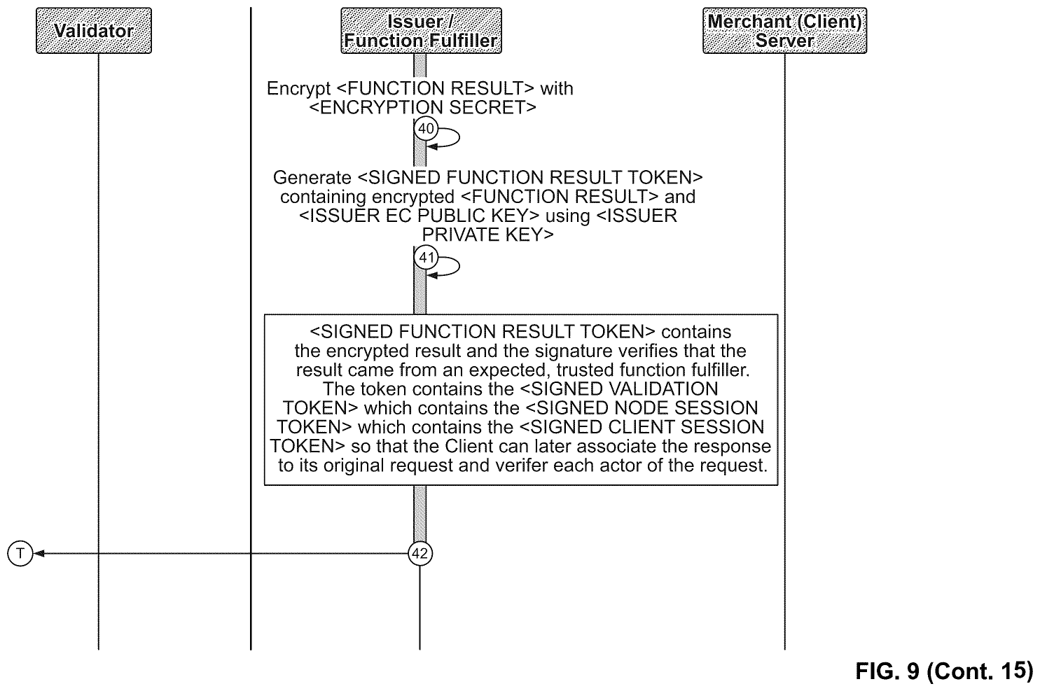

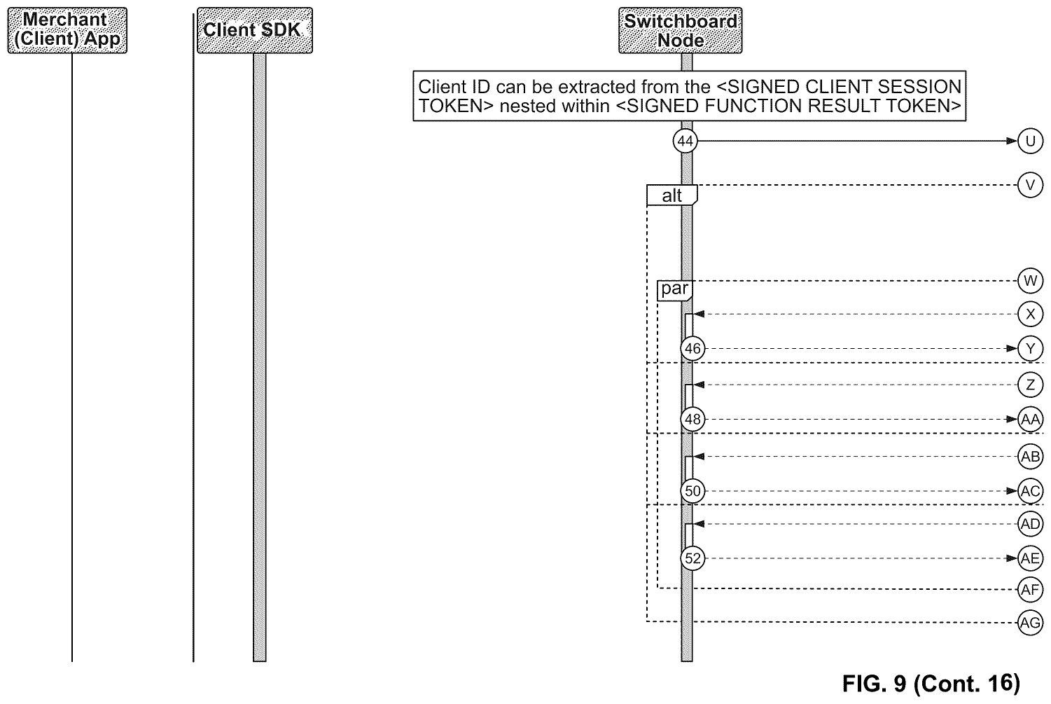

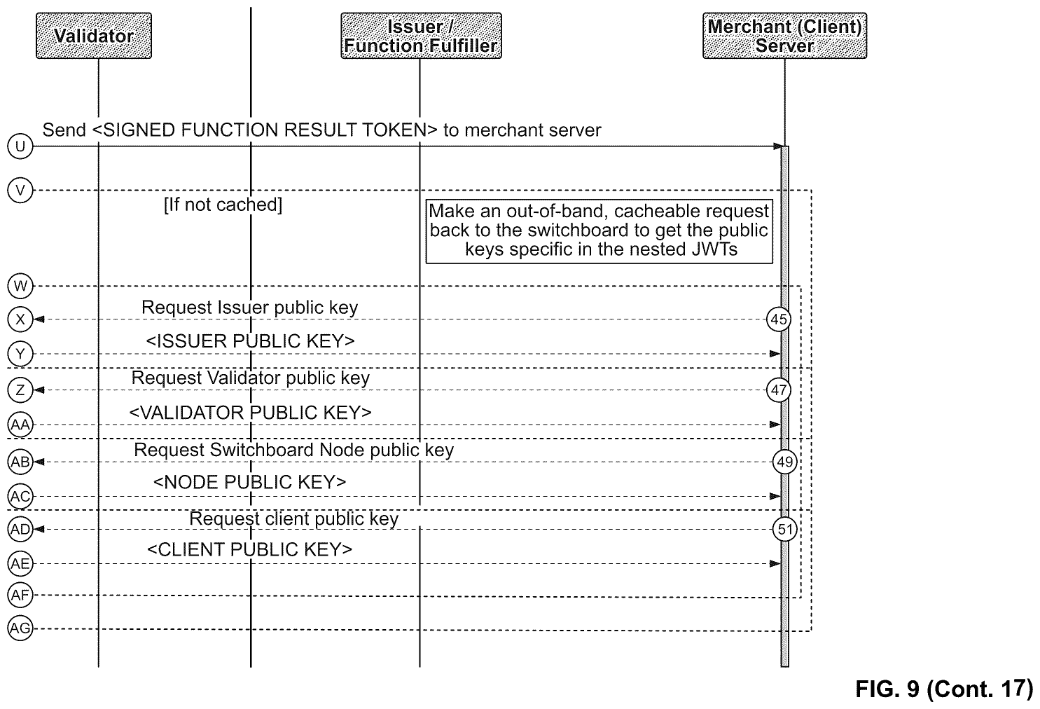

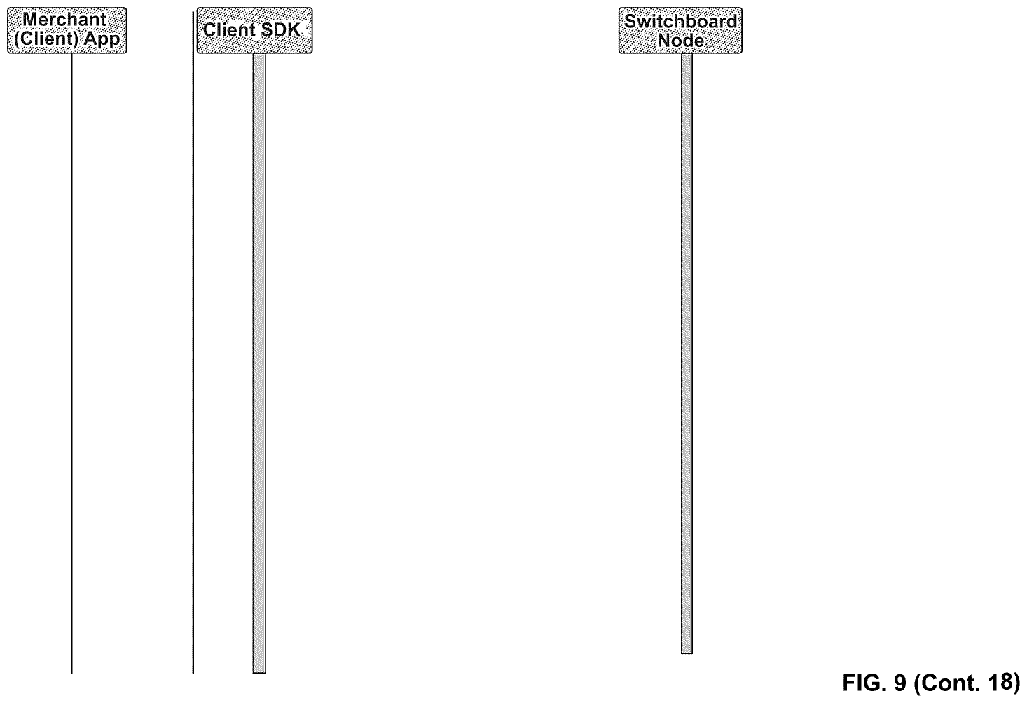

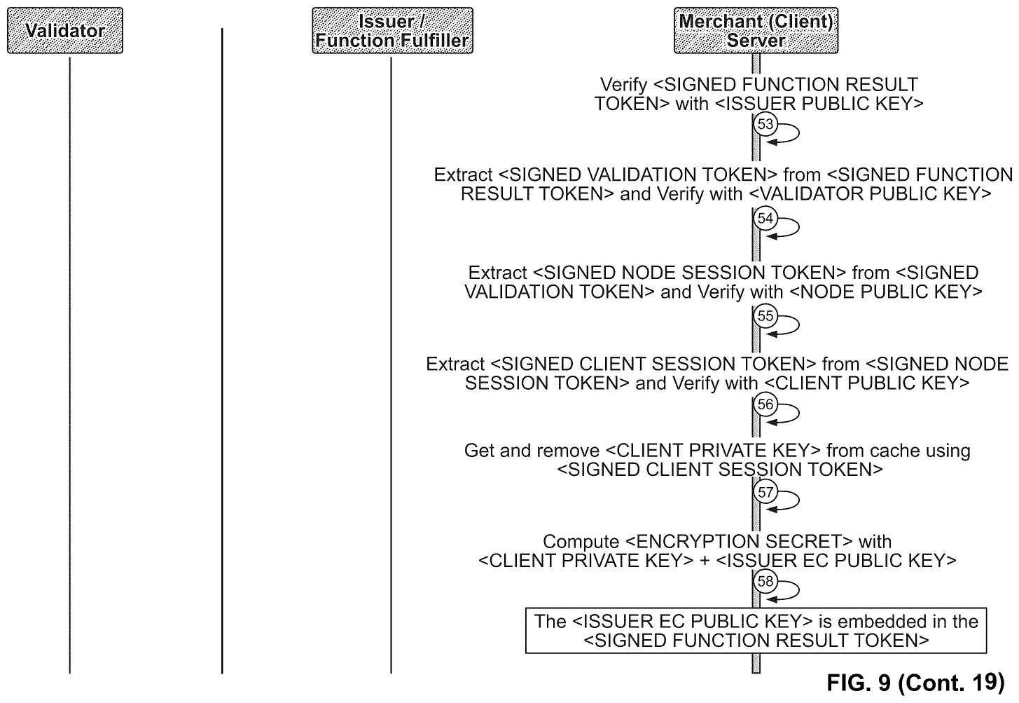

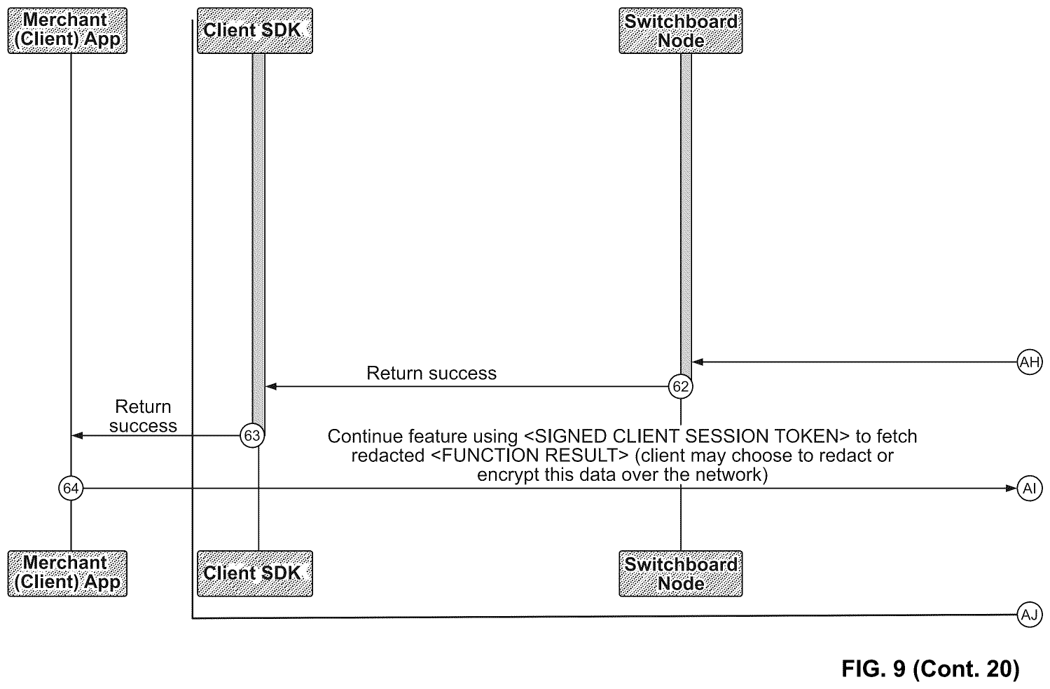

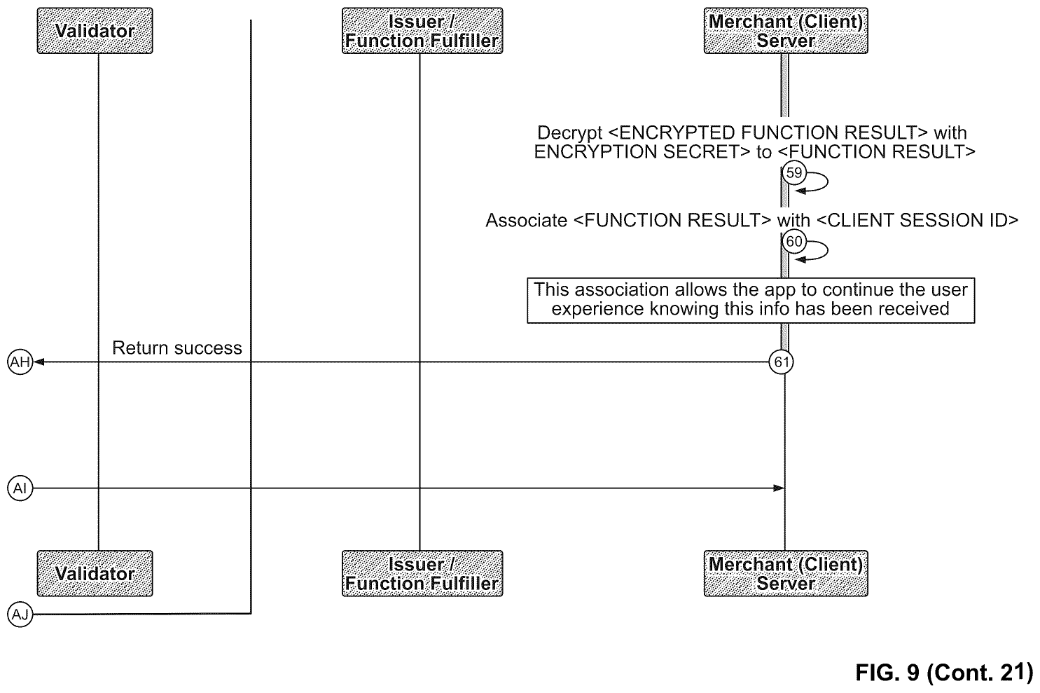

FIG. 9 illustrates an example sequence to perform operations between a merchant application, e.g., a client application associated with a merchant, and a merchant server, e.g., a client server associated with the merchant. The illustrated sequence includes actions and communications performed by the merchant application, a client SDK, a switchboard system including one or more nodes, a validator, an issuer and/or function fulfiller (IFF) (e.g., one or more client devices), and a merchant server.

In embodiments, the merchant application may be any application configured to execute on a merchant device (e.g., a client device), such as a banking application, a merchant application, a social media application, a travel application, a gaming application, a productivity application, an entertainment application, a POS application, and so forth. In embodiments, the merchant application includes a web browser to provide websites and pages. The merchant application may include and/or utilize the client SDK, which may be a set of instructions that enable the merchant application to communicate with other components of the switchboard system. In other embodiments, the merchant application does not include the client SDK and/or does not utilize the client SDK to communicate with other components of the switchboard system. For example, the merchant application can proxy through a back end service, which has the benefit of simplifying authentication, including in instances where the merchant application is aggregated into merchant organizations and/or the corresponding back end servers have network connectivity. The merchant application may function as a back end for front end (BFF) service operated by participating network entities. As other examples, the merchant application can communicate directly with other components of the switchboard system and the merchant application can communicate via one or more networks with other components of the switchboard system.

In embodiments, as shown in FIG. 9, at step 1 the merchant application can generate a session and a client session ID and transmit them to the merchant server. At step 2 the merchant application can generate an ECDH key request and provide the client session ID to the merchant server. In step 3, the merchant server can generate a client encryption public key and a client encryption private key using, e.g., Elliptic Curve P256. In embodiments, the generated keys can be half of the ECDH key used for encryption and/or decryption of personally-identifiable information (PII). In step 4, the merchant server can create client session information and with client session ID, client ID, client encryption public key, and client encryption public key ID. In step 5, the merchant server can generate a signed client session token. In embodiments, the signed client session token can be a JSON web token containing client session information signed with a client private key. In step 6, the merchant server can store the client encryption private key with the signed client session token. In step 7, the merchant server can return the signed client session token to the merchant application.

In step 8, the merchant application can initiate authentication, which can be performed by one or more of the methods described herein. In step 9, the client SDK can request a session for a function request with the signed client session token. In embodiments, the session can be used to establish temporary trust between the client, one or more nodes of the switchboard system, and the IFF and the session can be short-lived and tied to a message transmitting a nonce generated by the switchboard system. In step 10, the switchboard node can generate the nonce and a signed node session token. In embodiments, the signed node session token can be a JSON web token containing the nonce, signed client session token, and a function request signed with a node private key. In step 11, the switchboard node can return the signed node session token, nonce, function terms of service (TOS), and TOS version.

In embodiments the client SDK can obtain consent from a user for the function TOS prior to proceeding, e.g., requesting a tap of a contactless card. In step 12, the client SDK can capture and record user consent to the function TOS along with a consent date and the TOS version. In step 13, the client SDK can receive a tap of a contactless card, which can include a read of a message as described herein. In step 14, the client SDK can transmit the read message, signed node session token, consent date, and TOS version to the switchboard node. In step 15, the switchboard node can verify the signed node session signature. In embodiments, this step can confirm the session is valid using the appropriate key from the switchboard system configuration, e.g., stored in the memory of one or more nodes of the switchboard system. In step 16, the switchboard node can extract the issuer ID from the message and lookup the issuer hostname. In embodiments, the issuer ID can be used to route the validation request to the appropriate validator. In step 17, the switchboard node can generate correct authentication parameters for the selected validator. In embodiments, the switchboard system configuration will define how to authenticate with each validator and provide the necessary secrets.

In step 18, the switchboard node can request validation of the message and signed node session token from the validator. In an embodiment, shown in step 19 and step 20, if the necessary data is not cached, an out-of-band, cacheable request to the switchboard node can be made to obtain its public key to check the session. As illustrated in FIG. 9, in step 19, the validator can request the switchboard node public key and in step 20, the switchboard node can transmit the node public key to the validator. In step 21, the validator can verify the signed node session token signature with the node public key. In step 22, the validator can validate the message. In step 23, the validator can generate a signed validation token using the validator private key. In embodiments, the signed validation token provides verifiable proof that the validator successfully validated the message associate with this session. In embodiments, the signed validation token can contain the session token to ensure that the validation is tied only to this single session and pass through the context of the request in a single parameter.

In step 26, the validator can request function resolution from the IFF using the signed validation token, TOS version, and TOS consent date. In an embodiment, shown in steps 27-32, if the necessary data is not cached, the IFF can make requests to the switchboard node. As illustrated in FIG. 9, in step 27 the IFF can request the validator public key from the switchboard node and in step 28, the switchboard node can transmit the validator public key to the IFF. In step 29 the IFF can request switchboard node public key from the switchboard node and in step 30 the switchboard node can transmit the node public key to the IFF. In step 31, the IFF can request the client public key from the switchboard node and in step 32 the switchboard node can transmit the client public key to the IFF.

In step 33 the IFF can verify the signed validation token signature with the validator public key. In step 34, the IFF can extract the signed node session token from the signed validation token and verify the signature with the node public key. In step 35 the IFF can extract the signed client session token from the signed node session token and verify the signature with the client public key. In step 36, the IFF can store the TOS version, TOS consent date, and pUID. In embodiments, this can be the remainder of the ECDH key creation. In step 37, the IFF can generate an issuer encryption public key and an issuer encryption private key using, e.g., Elliptic Curve P256. In step 38, the IFF can generate an encryption secret from the issuer encryption private key and the client encryption public key. In embodiments, the client encryption public key can be embedded in the signed client session token. In step 39, the IFF can execute the function request to create a function result. In step 40, the IFF can encrypt the function result with the encryption secret. In step 41, the IFF can generate a signed function result token containing the encrypted function result and issuer encryption public key using the issuer private key. In embodiments, the signed function result token containing the encrypted result and the signature can verify that the result was received from an expected, trusted source, e.g., an expected, trusted function fulfiller. The token contains the signed validation token, which contains the signed node session token that contains the signed client session token so that the client can later associate the response to its original request and verify each actor of the request.

In step 42, the IFF can return the signed function result token to the switchboard node. In step 43, the switchboard node can use the client ID to lookup a client uniform resource locator (URL) in the switchboard system configuration. In embodiments, the client ID can be extracted from the signed client session token nested within the signed function result token. In step 44, the switchboard node can send the signed function result token to the merchant server. In an embodiment, shown in steps 45-52, if the necessary data is not cached, the merchant server can make requests to the switchboard node. As illustrated in FIG. 9, in step 45, the merchant server can request the issuer public key from the switchboard node and in step 46 the switchboard node can transmit the issuer public key to the merchant server. In step 47 the merchant server can request the validator public key from the switchboard node and in step 48 the switchboard node can transmit the validator public key to the merchant server. In step 49 the merchant server can request switchboard node public key from the switchboard node and in step 50 the switchboard node can transmit the node public key to the merchant server. In step 51 the merchant server can request the client public key and in step 52 the switchboard node can transmit the client public key to the merchant server.

In step 53 the merchant server can verify the signed function result token with the issuer public key. In step 54 the merchant server can extract the signed validation token from the signed function result token and verify the signed validation token with the node public key. In step 55 the merchant server can extract the signed node session token from the signed validation token and verify the signed node session token with the node public key. In step 56 the merchant server can extract the signed client session token from the signed node session token and verify the signed client session token with the client public key. In step 57 the merchant server can retrieve and remove the client private key from its cache using the signed client session token. In step 58 the merchant server can compute the encryption secret with the client private key and issuer encryption public key. In embodiments, the issuer encryption public key is embedded in the signed function result token.

In step 59 the merchant server can decrypt the encrypted function result with the encryption secret to yield the function result. In step 60 the merchant server can associate the function result with the client session ID. In embodiments, this association allows the merchant application to continue the user experience with knowledge that this information has been received. In step 61 the merchant server can return a success notification to the switchboard node. In step 62 the switchboard node can return a success notification to the client SDK. In step 63, the client SDK can return a success notification to the merchant application.

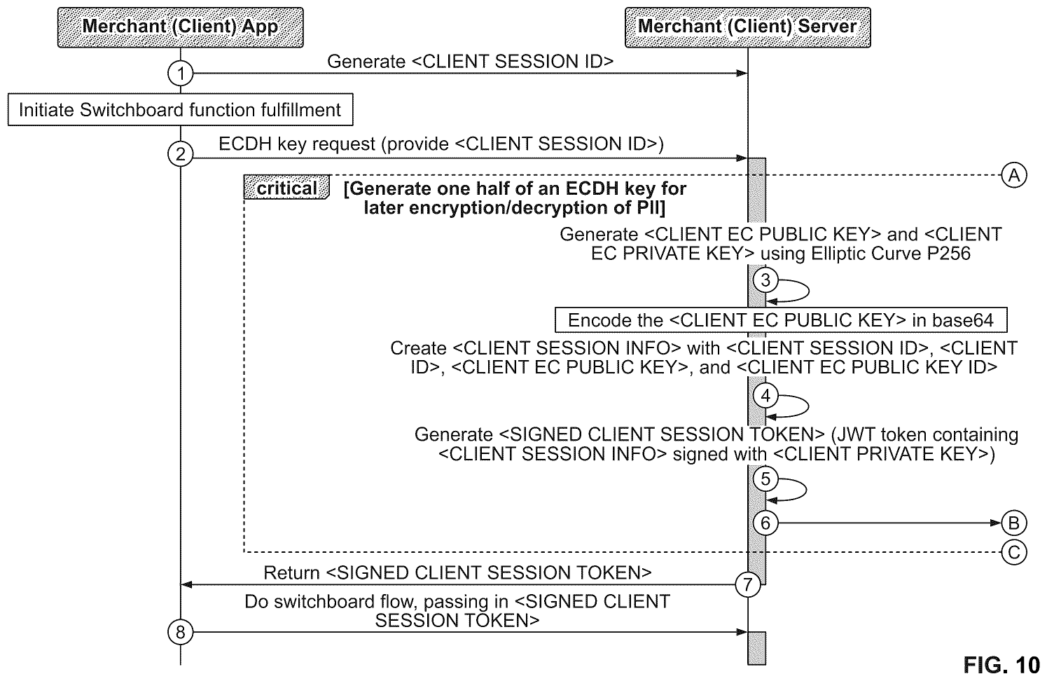

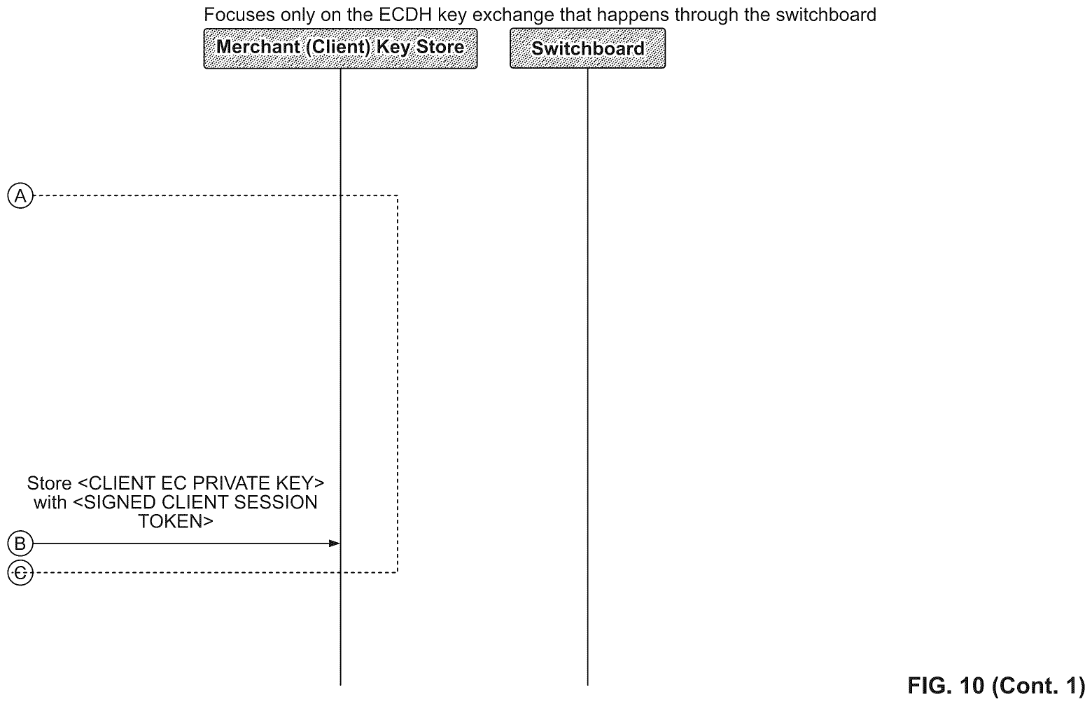

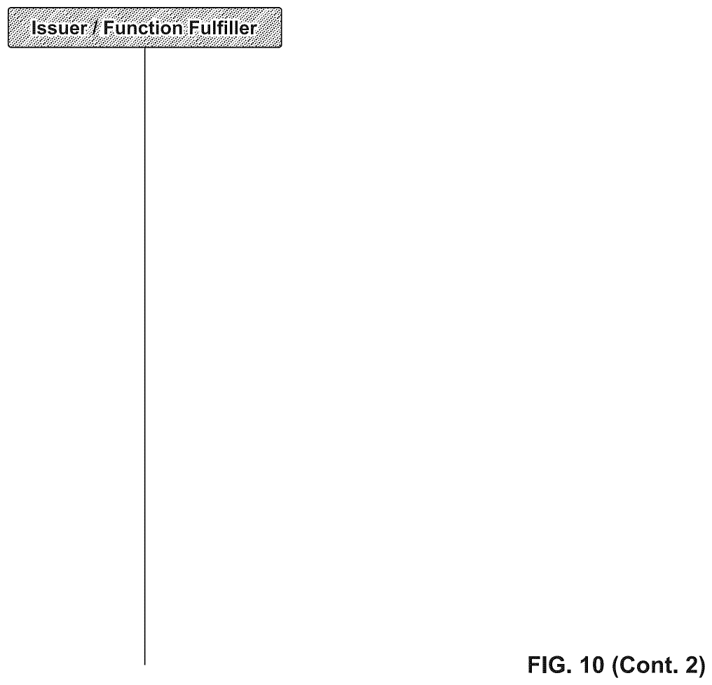

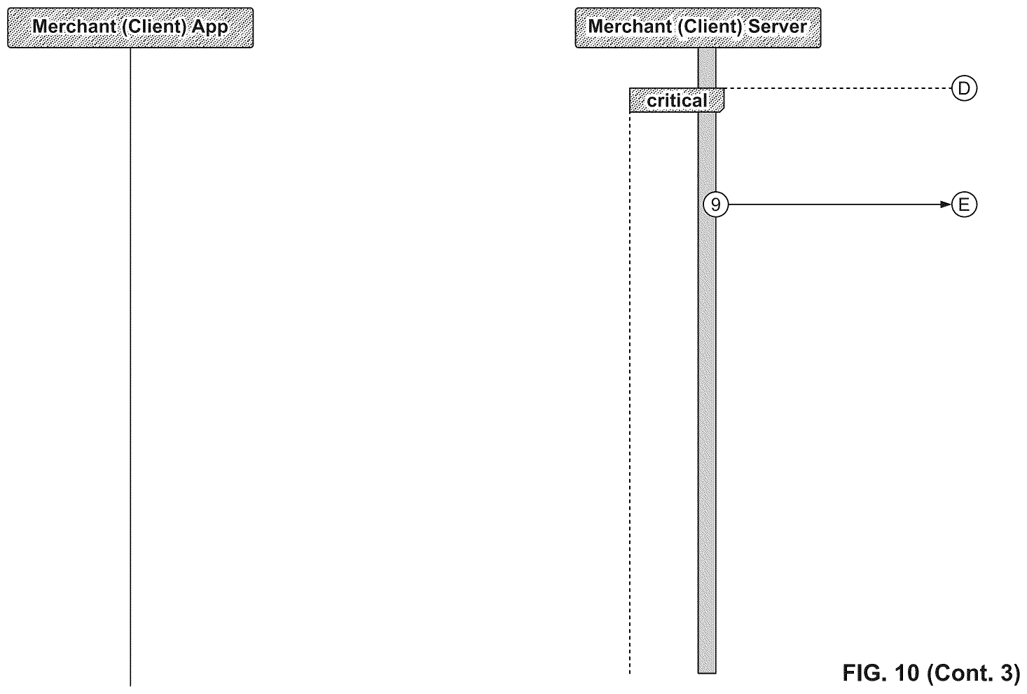

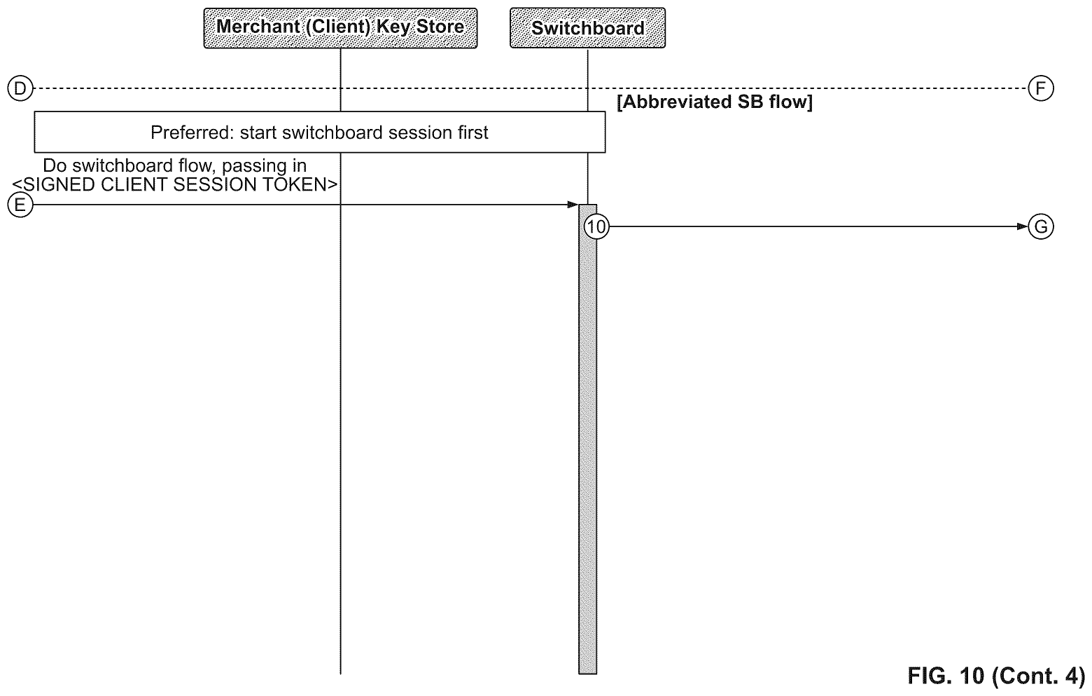

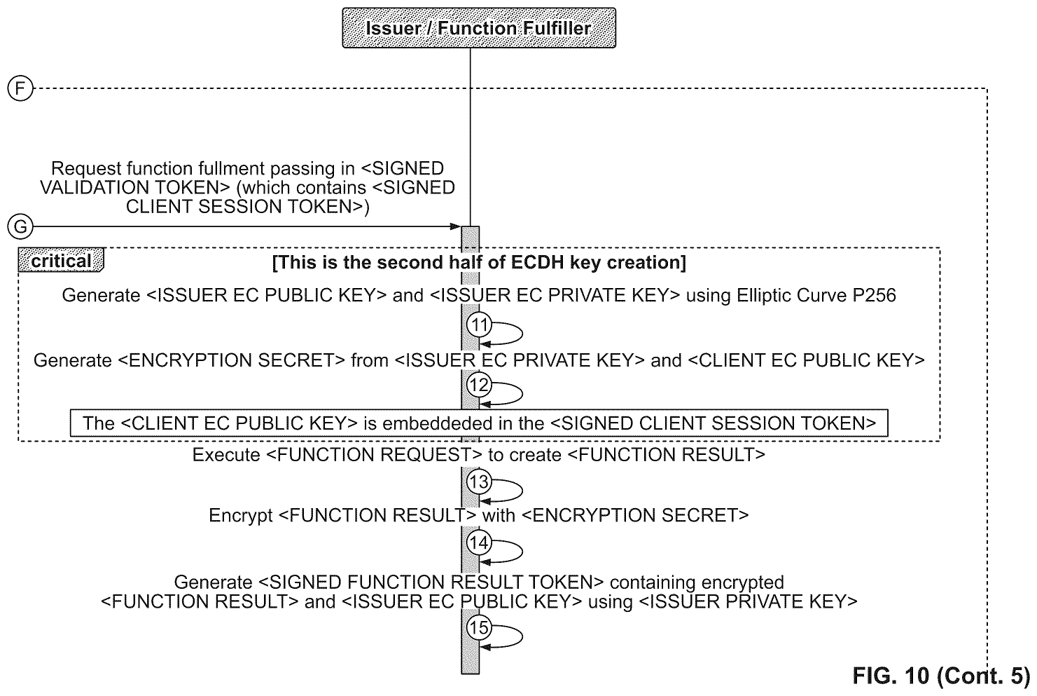

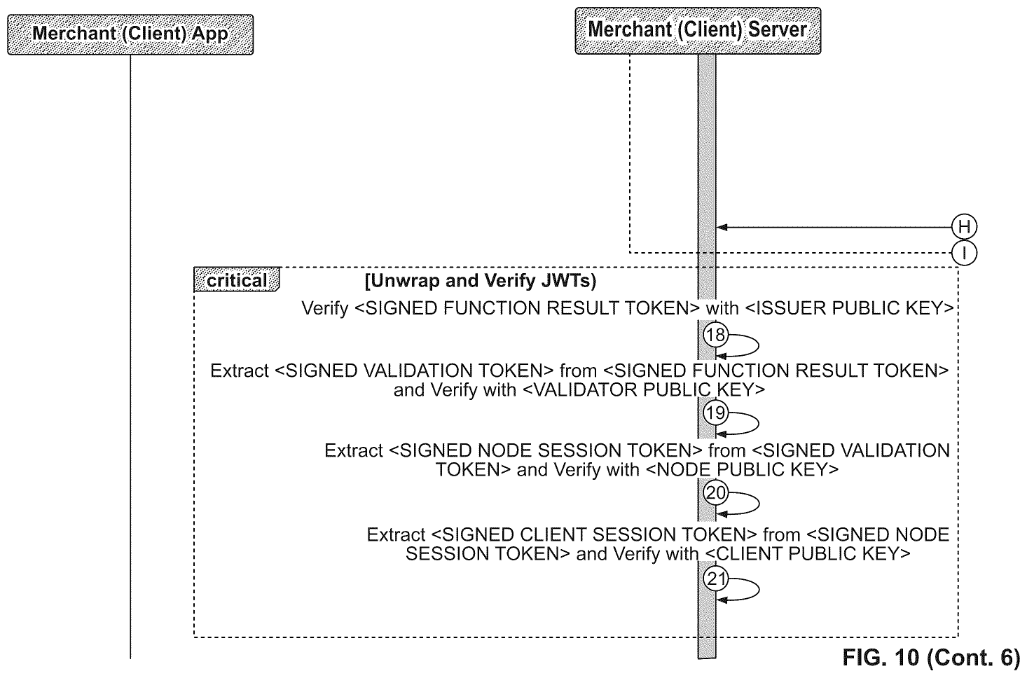

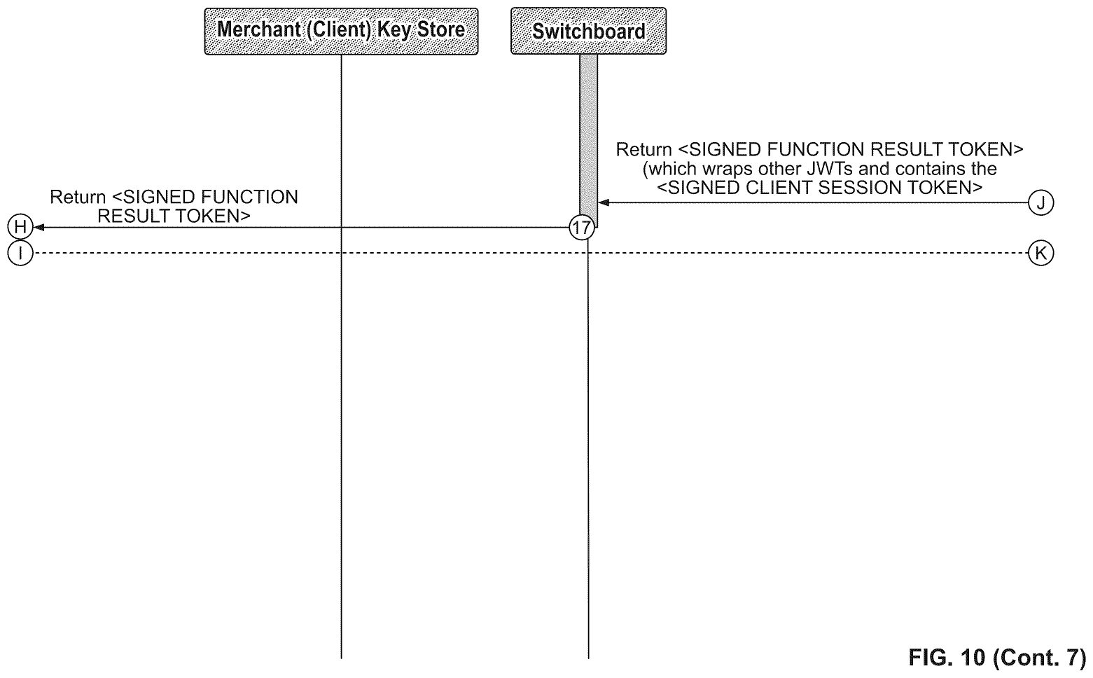

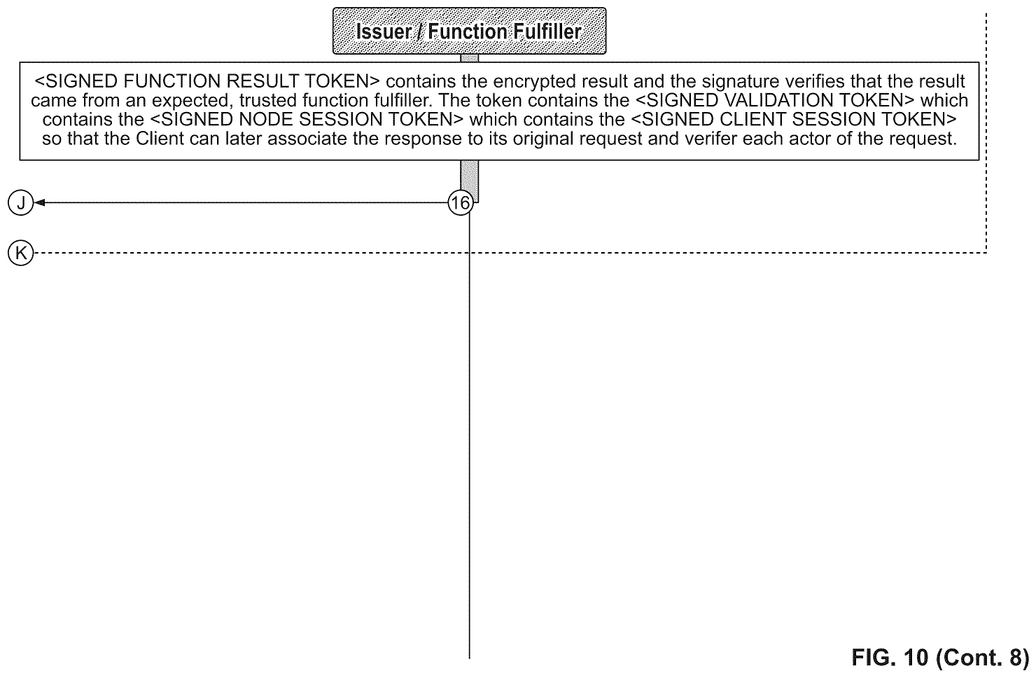

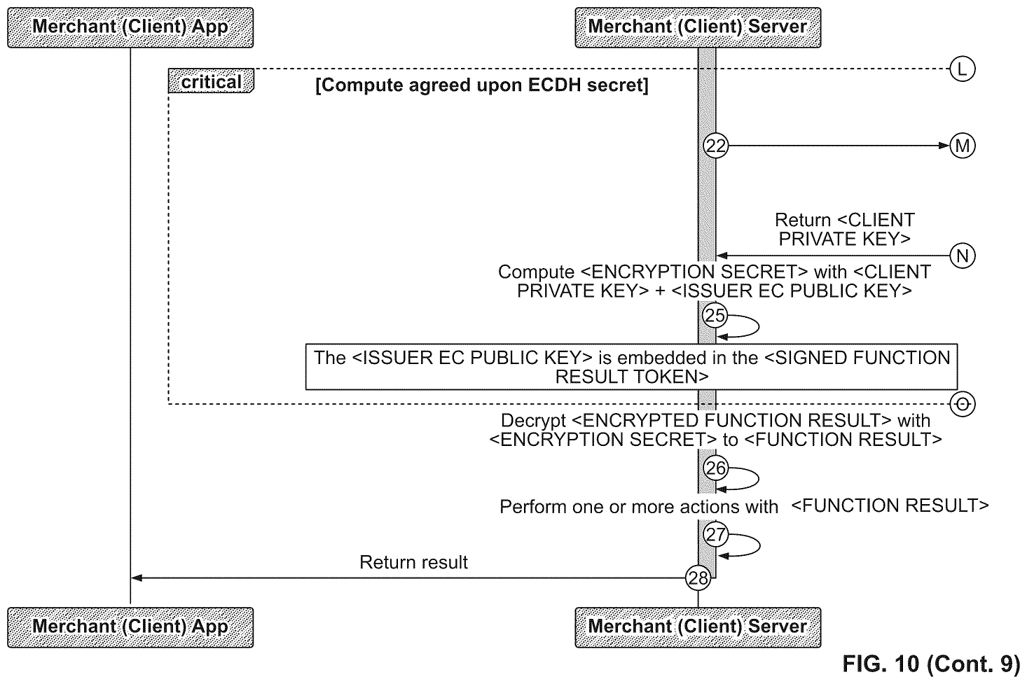

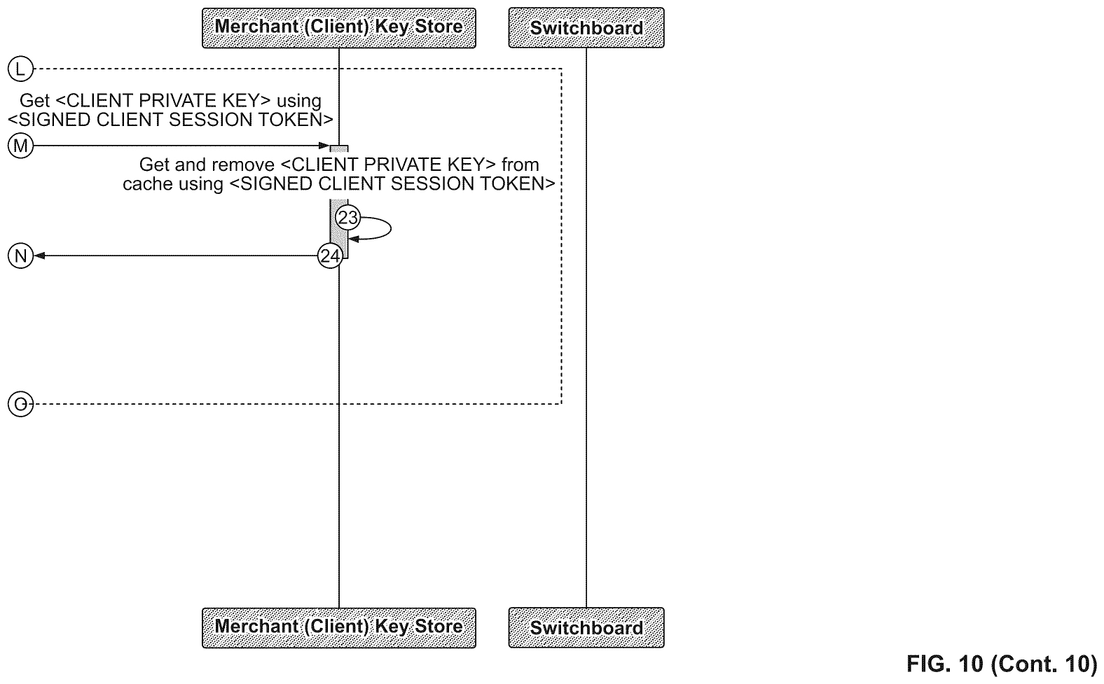

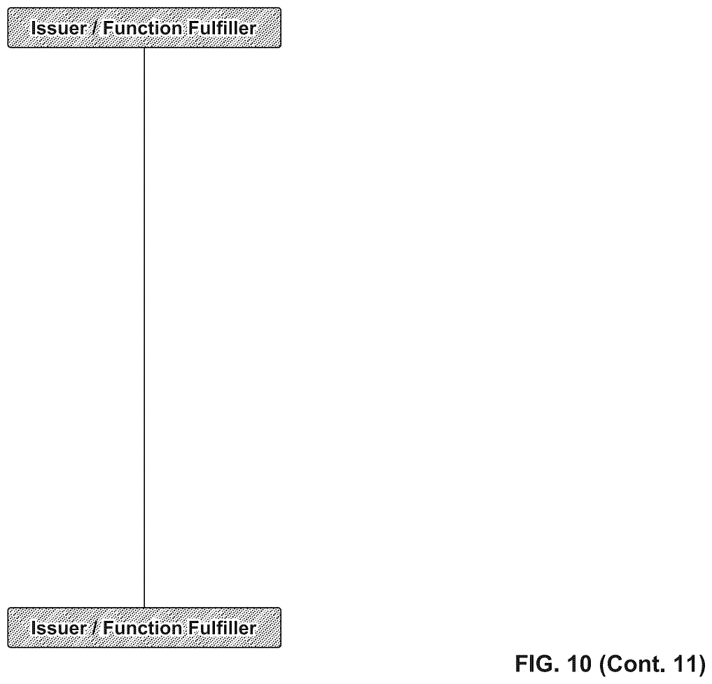

FIG. 10 illustrates an example sequence to perform operations between a merchant application, e.g., a client application associated with a merchant, a merchant server, e.g., a client server associated with the merchant, and an IFF. The illustrated sequence includes actions and communications performed by the merchant application, the merchant server, a merchant key store, the switchboard system including one or more nodes, and the IFF. In embodiments, the merchant application may be any application configured to execute on a merchant device (e.g., a client device), such as a banking application, a merchant application, a social media application, a travel application, a gaming application, a productivity application, an entertainment application, a POS application, and so forth. In embodiments, the merchant application includes a web browser to provide websites and pages. The merchant application may include and/or utilize the client SDK, which may be a set of instructions that enable the merchant application to communicate with other components of the switchboard system.

In embodiments, as shown in FIG. 10, at step 1 the merchant application can generate a session and a client session ID and transmit them to the merchant server. At step 2 the merchant application can generate an ECDH key request and provide the client session ID to the merchant server. In embodiments, steps 3-6 of FIG. 10 can be considered a critical sequence of operations for the generation of keys that can be half of the ECDH key used for encryption and/or decryption of PII. In step 3 the merchant server can generate a client encryption public key and a client encryption private key using, e.g., Elliptical Curve P256. In some embodiments, the client encryption public key can be encoded in base64. In step 4 the merchant server can create client session information with the client session ID, a client ID, the client encryption public key, and a client encryption public key ID. In step 5 the merchant server can generate a signed client session token. In embodiments, the signed client session token can be a JSON web token containing client session information signed with a client private key. In step 6, the merchant server can store the client encryption private key with the signed client session token in the merchant key store.

In step 7 the merchant server can return the signed client session token to the merchant application. In step 8 the merchant application can transmit the signed client session token to the merchant server to, e.g., facilitate routing of data as described herein. In embodiments, steps 9-17 of FIG. 10 can be considered a critical sequence of operations for routing data using the switchboard system as described herein. In step 9 a switchboard session can be started and the merchant server can transmit the signed client session token to the switchboard system. In step 10, the SS can request function fulfillment from the IFF and can pass to the IFF the signed validation token, which contains the signed client session token. In embodiments, steps 10-12 can be considered a critical sequence of operations for performing, by the IFF, the remainder of the ECDH key creation. In step 11 the IFF can generate an issuer encryption public key and issuer encryption private key using, e.g., Elliptical Curve P256. In step 12 the IFF can generate the encryption secret from the issuer encryption private key and client encryption public key. In embodiments, the client encryption public key can be embedded in the signed client session token. In step 13 the IFF can execute the function request to create a function result. In step 14 the IFF can encrypt the function result with the encryption secret. In step 15 the IFF can generate a signed function result token containing the function result and issuer encryption public key using the issuer private key. In embodiments, the signed function result token containing the encrypted result and the signature can verify that the result was received from an expected, trusted source, e.g., an expected, trusted function fulfiller. The token can contain the signed validation token, which can contain the signed node session token that can contain signed client session token so that the client can later associate the response to its original request and verify each actor of the request. In step 16 the IFF can return the signed function result token, which can wrap other JSON web tokens and can contain the signed client session token, to the SS. In step 17 the SS can return the signed function result token to the merchant server.

In embodiments, steps 18-21 of FIG. 10 can be considered a critical sequence of operations for unwrapping and verifying JSON web tokens. In step 18 the merchant server can verify the signed function result token with the issuer public key. In step 19 the merchant server can extract the signed validation token from the signed function result token and verify it with the validator public key. In step 20 the merchant server can extract the signed node session token from the signed validation token and verify it with the node public key. In step 21 the merchant server can extract the signed client session token from the signed node session token and verify it with the client public key.

In embodiments, steps 22-25 of FIG. 10 can be considered a critical sequence of operations for computing the agreed upon ECDH secret. In step 22 the merchant server can obtain, from the merchant key store, the client private key using the signed client session token. In step 23 the merchant key store can retrieve and remove the client private key from cache using the signed client session token. In step 24 the merchant key store can return the client private key to the merchant server. In step 25 the merchant server can compute the encryption secret with the client private key and issuer encryption public key. In embodiments, the issuer encryption public key is embedded in the signed function result token.

In step 26 the merchant server can decrypt the encrypted function result with the encryption secret to yield the function result. In step 27 the merchant server can perform one or more actions with the function result. In step 28 the merchant server can return the result of the one or more actions to the merchant application.

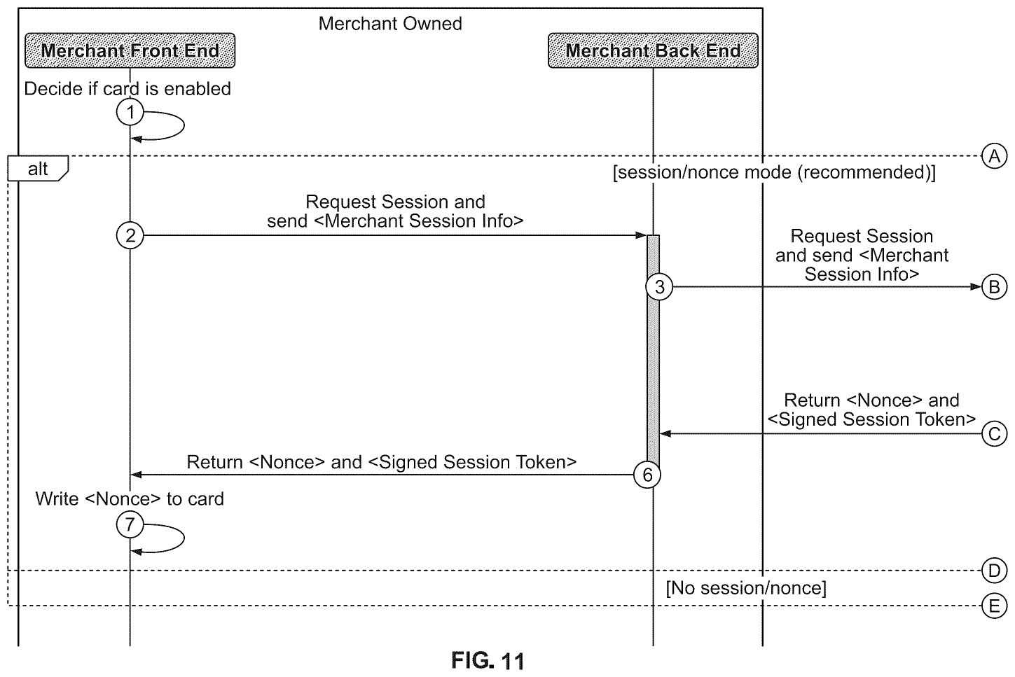

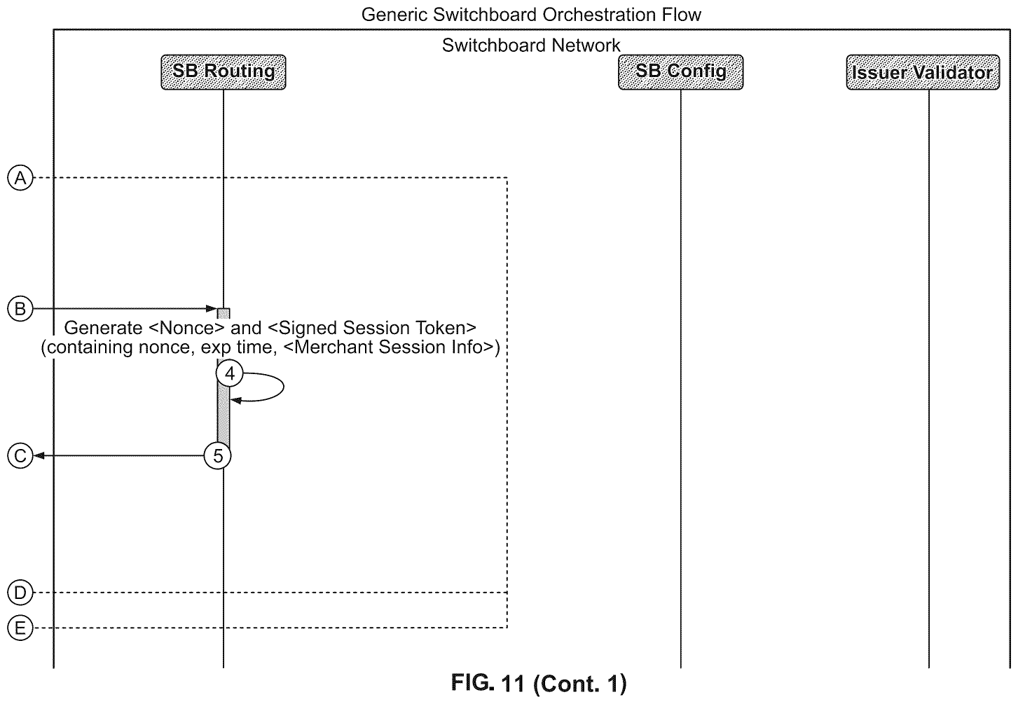

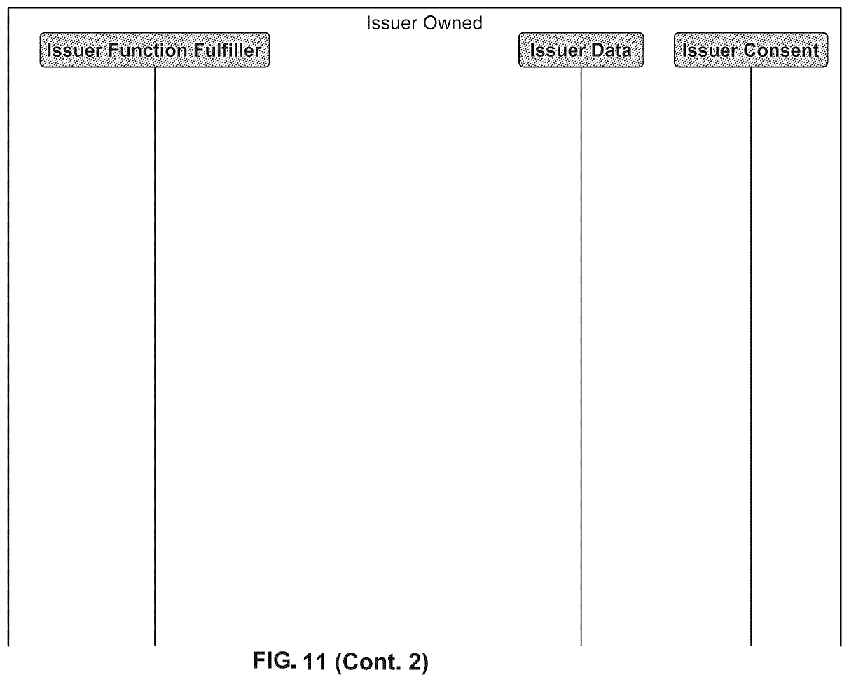

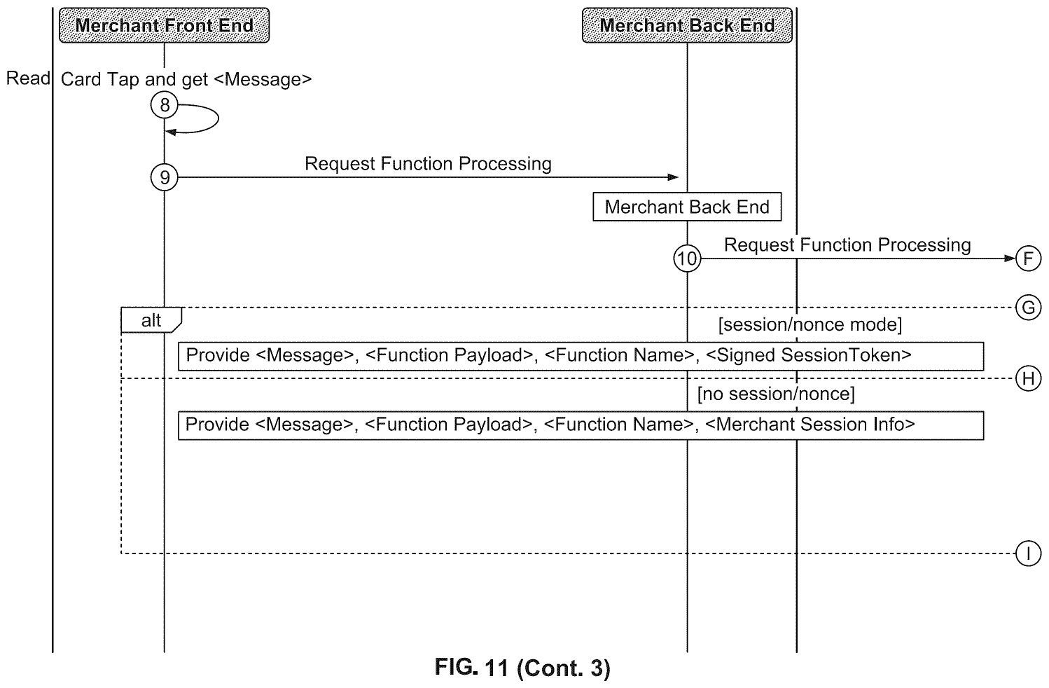

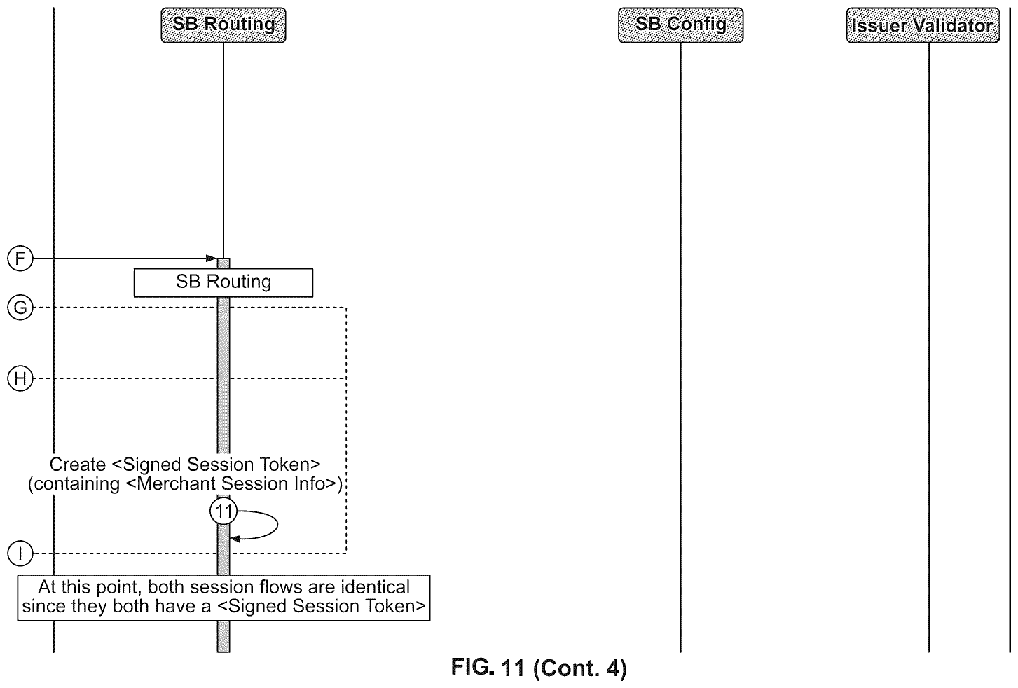

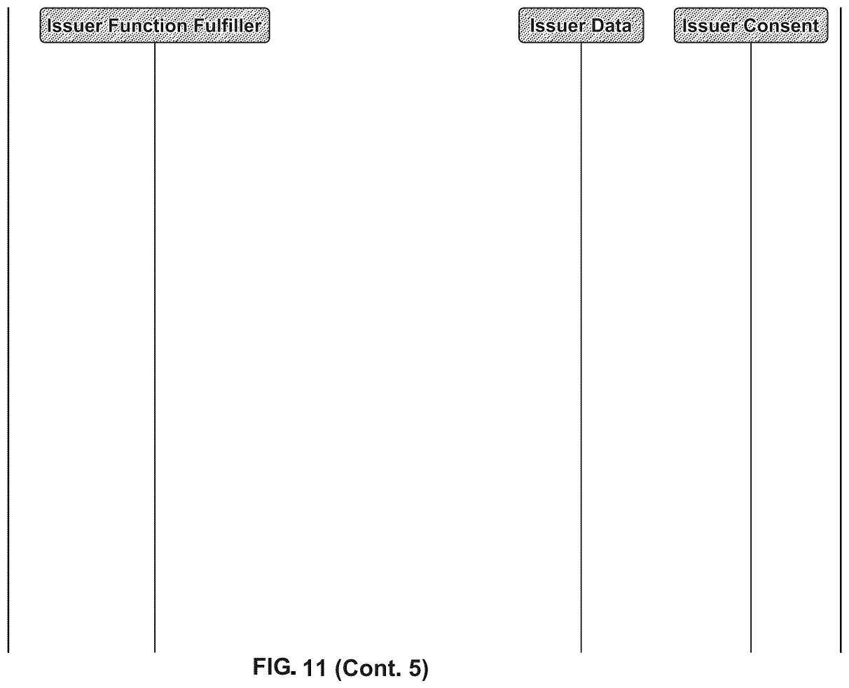

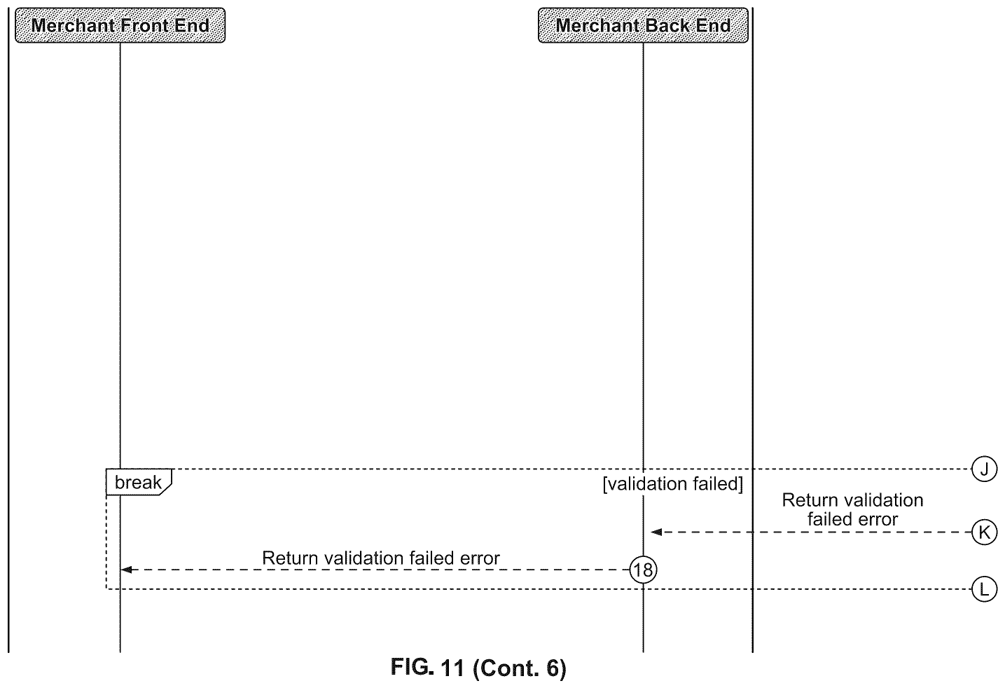

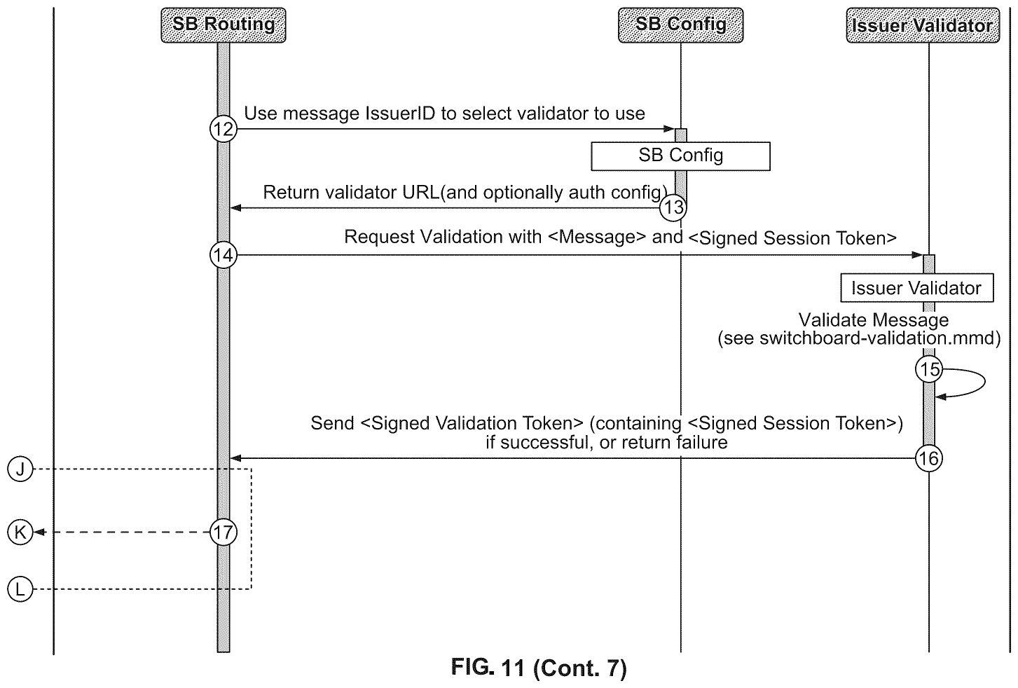

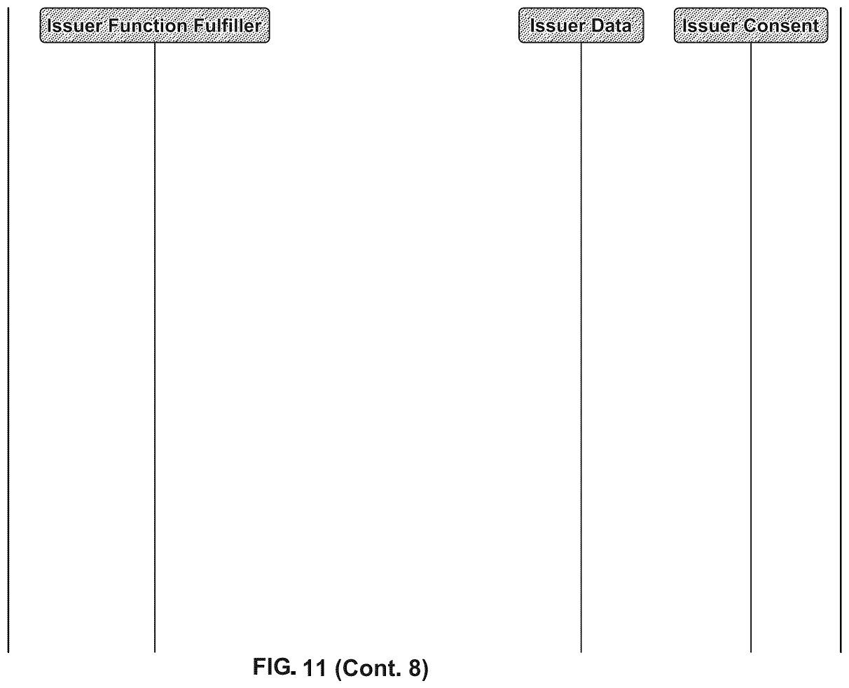

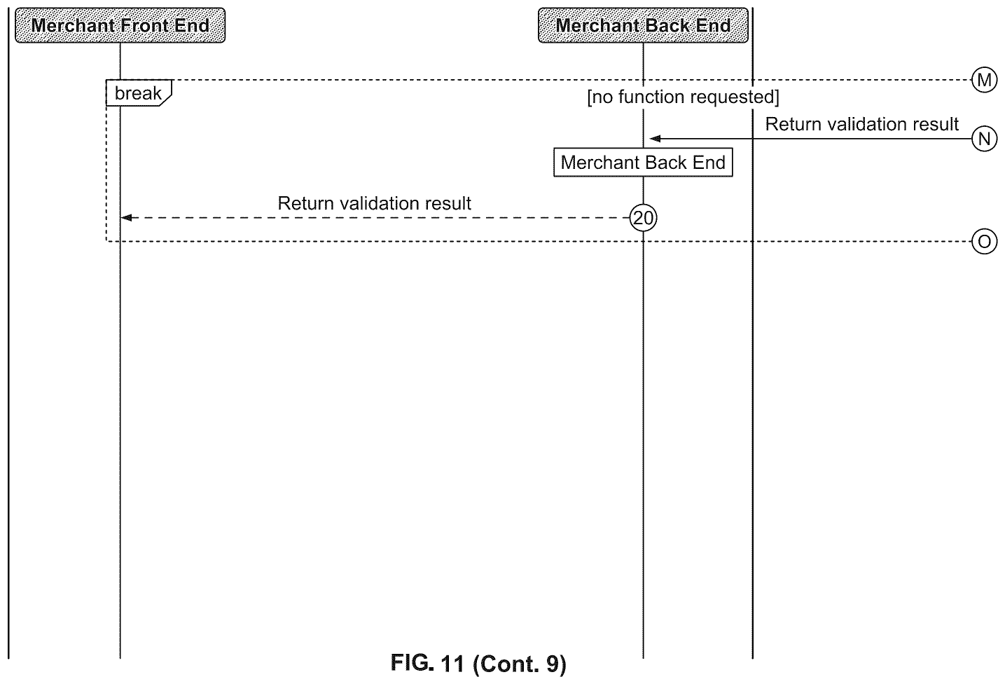

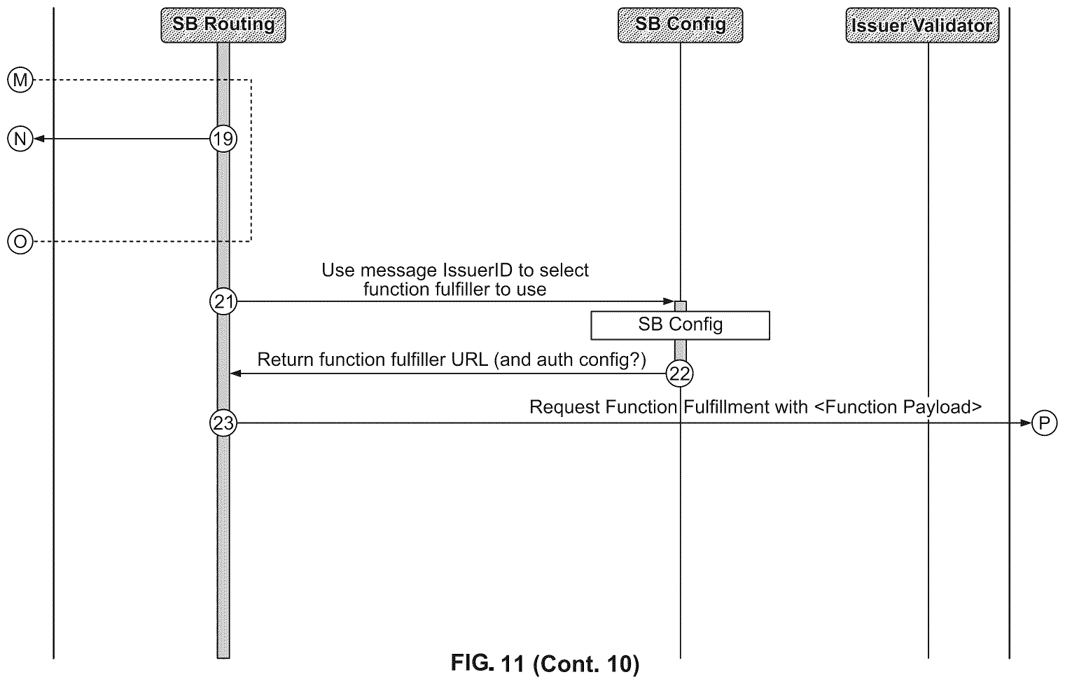

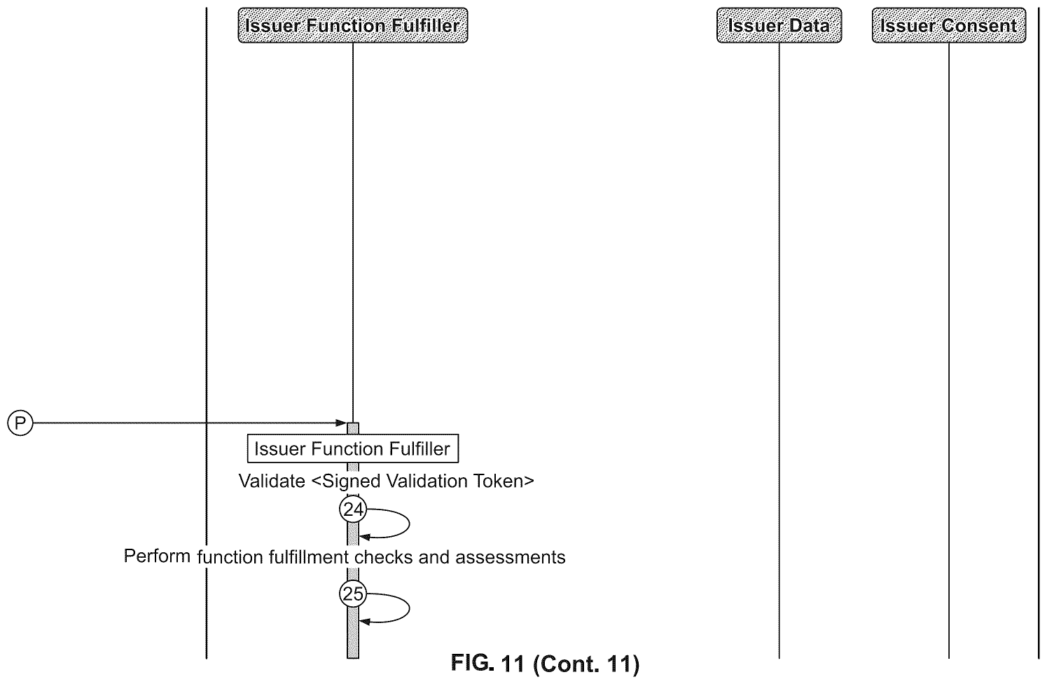

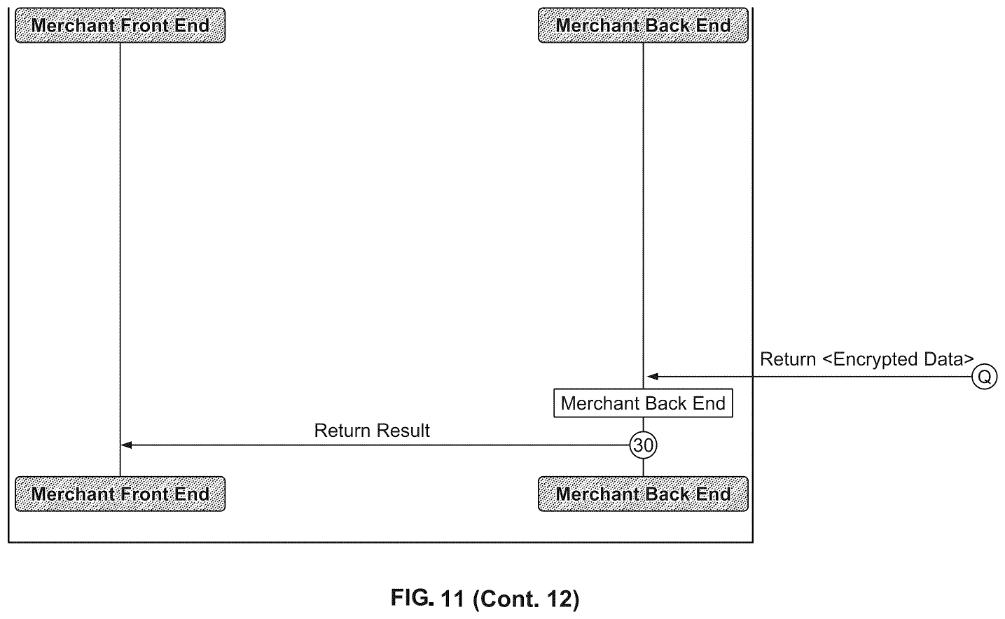

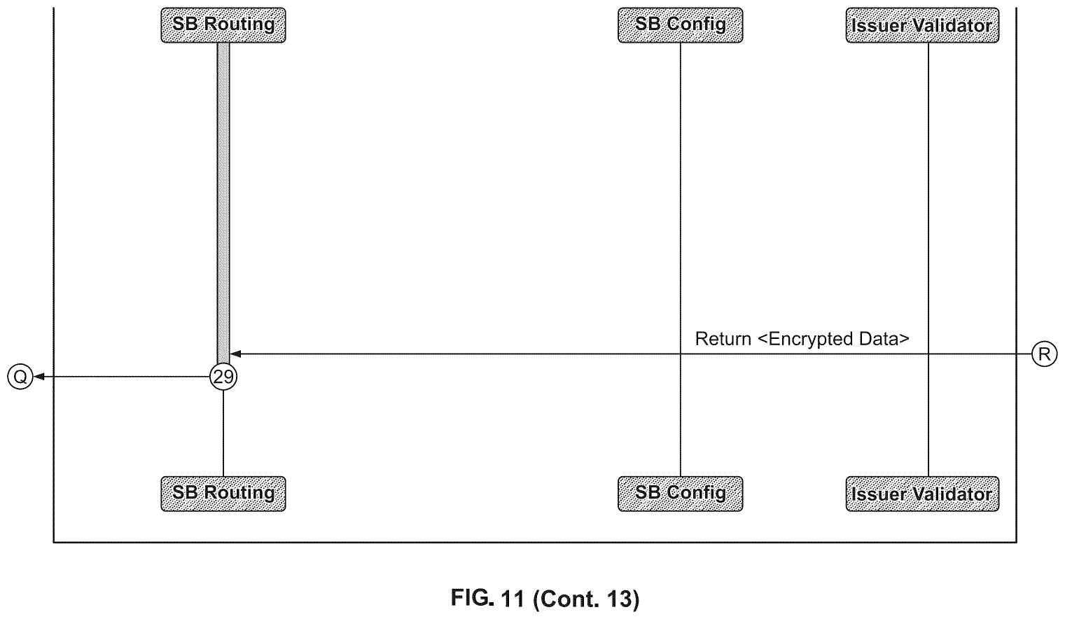

FIG. 11 illustrates an example sequence to perform operations between one or more merchant owned devices, including a merchant front end (e.g., one or more client devices associated with the merchant) and a merchant back end (e.g., one or more client devices associated with the merchant), a switchboard network as described herein, including a switchboard routing device (e.g., one or more nodes of the switchboard system), a switchboard configuration device (e.g., one or more nodes of the switchboard system), and an issuer validator device (e.g., one or more nodes of the switchboard system), and one or more issuer owned devices (e.g., an IFF, an issuer data device, and an issuer consent device). The illustrated sequence includes actions and communications performed by the merchant application, the merchant front end, merchant back end, switchboard routing device, switchboard configuration device, issuer validator device, IFF, issuer data device, and issuer consent device. In embodiments, the one or more merchant owned devices can execute one or more applications, such as a banking application, a merchant application, a social media application, a travel application, a gaming application, a productivity application, an entertainment application, a POS application, and so forth. In embodiments, the one or more applications can include a web browser to provide websites and pages. The one or more applications may include and/or utilize the client SDK, which may be a set of instructions that enable the merchant application to communicate with other components of the switchboard system.

In embodiments, as shown in FIG. 11, at step 1 the merchant front end can detect if a contactless card is enabled to engage with, and perform, one or more the functions described herein. In embodiments, steps 2-7 of FIG. 11 can be considered a sequence performed when using a session and/or nonce if the contactless card is configured to do so. In step 2, the merchant front end can request a session and transmit merchant session info from the merchant back end. In step 3 the merchant back end can request the session and transmits the merchant session information to the switchboard routing device. In step 4 the switchboard routing device can generate a nonce and a signed session token, which can contain the nonce, an expiration time, and the merchant session information. In step 5 the switchboard routing device can transmit the nonce and the signed session token to the merchant back end. In step 6, the merchant back end can transmit the nonce and signed session token to the merchant front end. In step 7 the merchant front end can write the nonce to the contactless card.

In embodiments, steps 8-11 as shown in FIG. 11 can be considered a sequence performed when not using a session and/or nonce if the contactless card is not so configured. In step 8 the merchant front end can read a contactless card and obtain a message. In step 9 the merchant front end can request function processing from the merchant back end. In step 10 the merchant back end can request function processing from the switchboard routing device. In connection with the prior sequence FIG. 11 illustrates two alternatives for step 11. In the first alternative, if a session and/or nonce is being used, the merchant front end can transmit the message, a function payload, a function name, and a signed session token to the merchant back end and the merchant back end can transmit these to the switchboard routing device. In the second alternative, if a session and/or nonce is not being used, the merchant front end can transmit the message, a function payload, a function name, and merchant session information to the merchant back end, the merchant back end can transmit these to the switchboard routing device, and the switchboard routing device can create a signed session token containing the merchant session information. At this point in the sequence, under both alternatives the switchboard routing device possesses the signed session token.

In step 12 the switchboard routing device can request, from the switchboard configuration device, a validator using the message issuer ID. In step 13 the switchboard configuration device can return a validator URL and, in embodiments, an authentication configuration. In step 14 the switchboard routing device can request, from the issuer validator device, validation with the message and signed session token. In step 15 the issuer validator device can validate the message as described herein. In step 16 the issuer validator device can transmit the signed validation token, which can include the signed session token, if validation is successful to the switchboard routing device. If validation is unsuccessful, a failure notification can be transmitted by the issuer validator device to the switchboard routing device, and in step 17 the switchboard routing device can transmit the failure notification to the merchant back end and in step 18 the merchant back end can transmit the failure notification to the merchant front end. If validation is successful, in step 19 the validation result can be transmitted by the switchboard routing device to the merchant back end and in step 20 the validation result can be transmitted from the merchant back end to the merchant front end.

In step 21 the switchboard routing device can request, from the switchboard configuration device, a function fulfiller using the message issuer ID. In step 22 the switchboard configuration device can return a fulfiller URL and, in embodiments, an authentication configuration. In step 23 the switchboard routing device can request fulfillment of a function with the function payload from the IFF. In step 24 the IFF can validate the signed validation token as described herein. In step 25 the IFF can perform any necessary function fulfillment checks and assessment. In embodiments, this can include checking that the user consented to the TOS and that the TOS shown to the user were correct. In step 26 the IFF can complete the function. In step 27 the IFF can encrypt data related to the function. In embodiments, this data can include merchant session information, which can contain key exchange information, or can use pre-established keys between a merchant and an issuer. In step 28 the IFF can transmit the encrypted data to the switchboard routing device. In step 29 the switchboard routing device can transmit the encrypted data to the merchant back end. In step 30 the merchant back end can transmit the result of the function to the merchant front end.

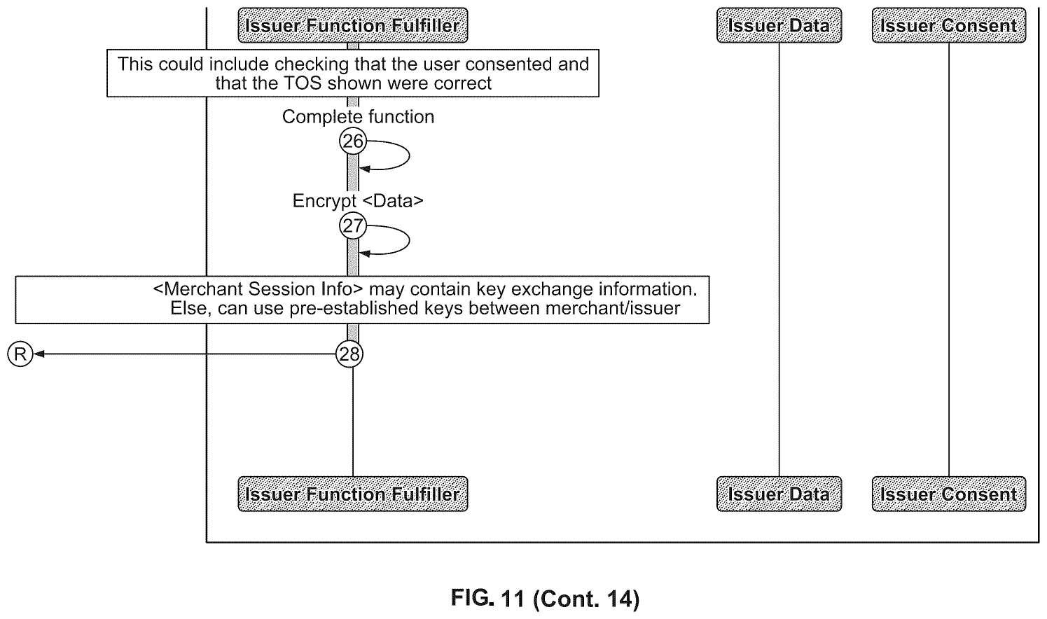

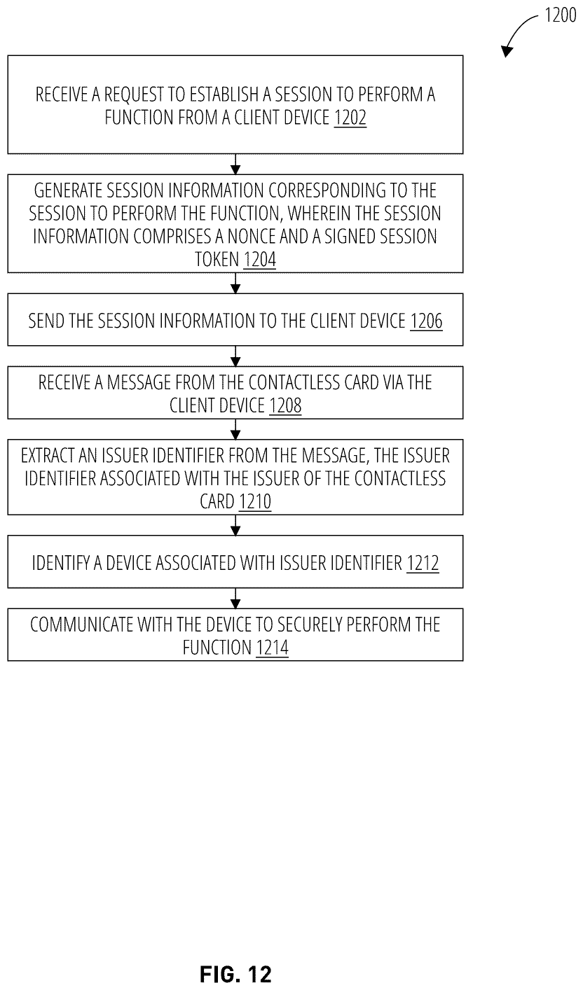

FIG. 12 illustrates an example of method 1200 in accordance with embodiments discussed herein. In block 1202, the method 1200 includes receiving, by a node in a system, a request to establish a session to perform a function from a client device, wherein the function is at least partially performed utilizing a contactless card, such as contactless card 102. In some instances, the node may be one of a plurality nodes of a switchboard system. The node may be previously selected by the sending device via a DNS operation performed.

In block 1204, the method 1200 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1206, method 1200 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 8).

In block 1208, method 1200 includes receiving, by the node, a message from the contactless card via the client device. The message may be generated by the contactless card. FIG. 8 illustrates one example of a message 800. In some embodiments, the node verifies the message. For example, the node may verify a nonce in the message and a signed session token.

In block 1210, method 1200 extracts an issuer identifier from the message by the node, the issuer identifier associated with the issuer of the contactless card. In some instances, the issuer identifier may be in a plaintext format.

In block 1212, method 1200 identifies, by the node, a device associated with the issuer identifier. For example, the node may perform a lookup to determine a server associated with the issuer identifier and the function to be performed.

In block 1214, method 1200 communicates, by the node, with the device to securely perform the function.

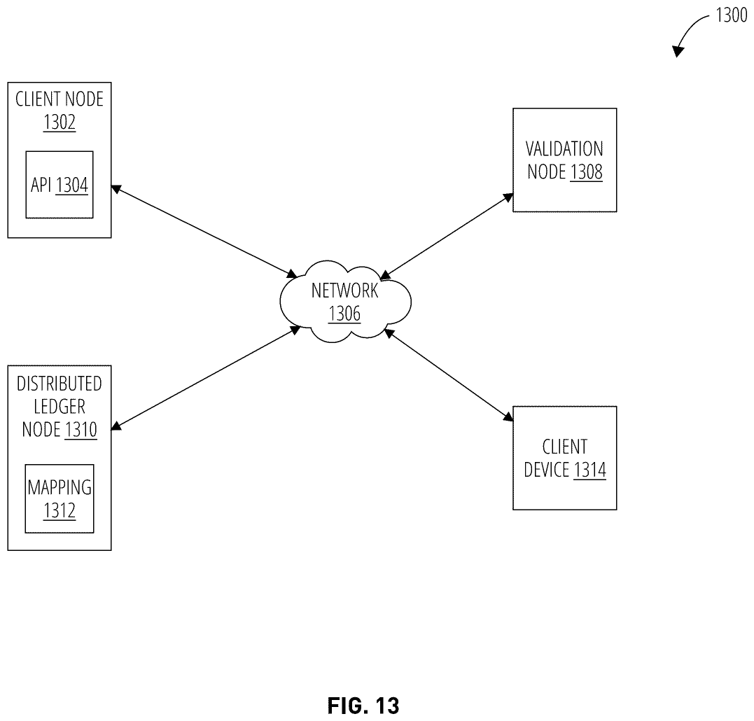

FIG. 13 illustrates a distributed network authentication system 1300 according to an example embodiment. As further discussed below, system 1300 can include client node 1302, API 1304, network 1306, distributed ledger node 1310, mapping 1312, and client device 1314. Although FIG. 13 illustrates single instances of the components, system 1300 can include any number of components.

System 1300 can include a client node 1302, which can be a network-enabled computer as described herein. In some examples, client node 1302 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, client node 1302 can execute one or more applications, such as software applications, that enable, for example, network communications with one or more components of system 1300, transmit and/or receive data, and perform the functions and processes described herein.

The client node can contain an API 1304. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1304 to interact with the service, such as by performing a remote call to an API for interacting with a web-based service.

API 1304 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1302 can communicate with one or more other components of system 1300 either directly or via network 1306. Network 1306 can comprise one or more of a wireless network, a wired network or any combination of wireless network and wired network, and may be configured to connect the components of system 1300. While FIG. 13 illustrates communication between the components of system 1300 through network 1306, it is understood that any component of system 1300 can communicate directly with another component of system 1300, e.g., without involving network 1306.

System 1300 can include a validation node 1308, which can be a network-enabled computer as described herein. In some examples, validation node 1308 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, validation node 1308 can execute one or more applications, such as software applications, that enable, for example, network communications with one or more components of system 1300, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1300 can include a distributed ledger node 1310, which can be a network-enabled computer as described herein. In some examples, distributed ledger node 1310 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, distributed ledger node 1310 can execute one or more applications, such as software applications, that enable, for example, network communications with one or more components of system 1300, transmit and/or receive data, and perform the functions and processes described herein.

Distributed ledger node 1310 can containing a mapping 1312. In some examples, mapping 1312 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1300, or the one or more databases can be hosted externally to any component of the system 1300. In some examples, the one or more databases can be contained in the distributed ledger node 1310, and in other examples the one or more databases can be stored outside of distributed edger node 1310 but in data communication with distributed ledger node 1310. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1310. In other examples, the one or more databases can be remote from distributed ledger node 1310 but in data communication with distributed ledger node 1310. Data communication between the one or more databases and distributed ledger node 1310 can be a direct data communication or data communication via a network, such as the network 1306.

In some examples, client node 1302 can be in data communication with distributed ledger node 1310. Distributed ledger node 1310 can contain mapping 1312. Mapping 1314 may include, e.g., a mapping between a validation node address and the validation node 1308, a mapping between a routing number and a validation node address, and/or a mapping between a routing number and validation node 1308. In some examples, mapping 1312 can include a digital signature associated with an entity having permission to validate for a routing number. Based on one or more of these associations, client node 1302 can call validation node for validation and/or provide direction to the client device to reach the appropriate validation node. This can be accomplished by calling a validation API associated with validation node 1308.

In some examples, iterations of the mappings described herein, such as mapping 1312, can also include a software or applet version number. The version number can be used to identify a validation node or validation node address or choose between multiple validation addresses for one validation node.

In some examples, client node 1302 and distributed ledger node 1310 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1310 can update mapping 1312 to reflect a different association between, e.g., a routing number, a validation node address, and a validation node. In some examples, degrees of permissions can be issued. For example, if client node 1302 were to function to route data to validation node 1308 (or other validation nodes), client node 1302 can be given a certain level of permissions. As another example, if distributed ledger node 1310 were to have the capability to update mapping 1312, distributed ledger node 1310 can have a different, higher level of permissions.

System 1300 can include a client device 1314, which can be a network-enabled computer as described herein. In some examples, distributed ledger node 1314 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300. Client device 1314 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1314 can be in data communication with another network-enabled computer not shown in FIG. 13, such as a smart card (e.g., a contactless card or a contact-based card).

In some examples, client device 1314 can execute one or more applications, such as software applications, that enable, for example, network communications with one or more components of system 1300, transmit and/or receive data, and perform the functions and processes described herein.

In some examples, upon receipt of an authentication request, client device 1314 can call (e.g., via an API) client node 1302. The call can include a routing number and/or an applet or software version number, and client node 1302 can query distributed ledger node 1310 and mapping 1312. Once the query returns the identification of a validation node (e.g., validation node 1308) and/or a validation node address associated with that routing number and/or applet or software version, client node 1302 can reply to client device 1314. Client device 1314 can then proceed with authentication with the validation node. The authentication can be performed by, e.g., the systems and methods described herein, such as by the generation, encryption, transmission, decryption, and validation of a cryptogram as described herein.

In some examples, client node 1302 can be co-resident with validation node 1308. In these examples, client node 1302 can handle the authentication in a single call from client device 1314. In some examples, this can be acceptable only if it is permissible for the full authentication transmission (e.g., a cryptogram as described herein) to be sent to client nodes that are not involved in authentication.

In some examples, if client node 1302 receives, from client device 1314, a routing number that is not handled by its location, client node 1302 can return a code indicating that this routing number is not handled, along with validation node address for the responsible validation node. Client device 1314 can then send the full authentication transmission to validation node 1308 using the received validation node address.

In some examples, client node 1302 can enter the distributed network with different permissions. For example, client node 1302 can be a read-only router of data. As another example, client node 1302 can have permission to send messages to distributed ledger node 1310 updating one or more routing paths for one or more routing numbers. However, client node 1302 would be prevented from updating one or more routing paths for one or more routing numbers for other entities that control other routing numbers which are not associated with client node 1302 or that did not grant this permission. As another example, distributed ledger node 1310 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1302, distributed ledger node 1310, and/or validation node 1308, if security, legal, and/or financial conditions are met, however, delegation is not required.

In some examples, one or more APIs can facilitate communication between components of system 1300 via network 1306. In other examples, one or more APIs are not required. Rather, the components of system 1300 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1308 for authentication, can require storage of the keys in one or more HSMs, to promote key security and ensure that the keys are never entered into memory.

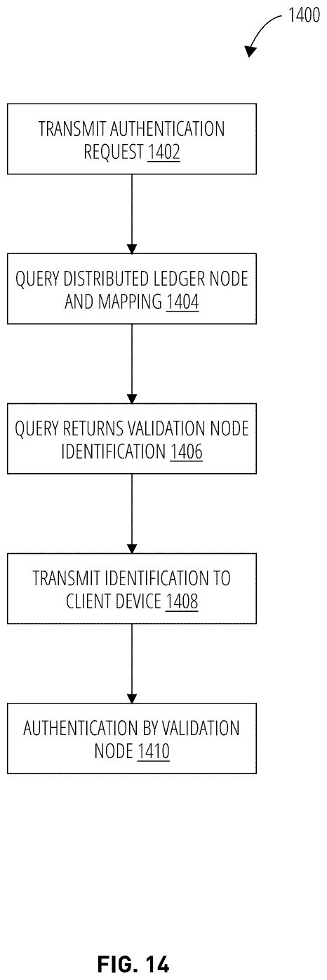

FIG. 14 illustrates a method 1400 performed by a distributed network authentication system according to an example embodiment. For example, the method can be performed by distributed network authentication system 1300 and or by another distributed network authentication system.

In block 1402, a client device can transmit an authentication request to a client node. The authentication request can include, without limitation, a routing number, a software version number, and/or an applet version number. The request can be made by an API call or other communication between the client device and the client node.

In block 1404, after receiving the authentication request, the client node can transmit a query (e.g., via an API call) to a distributed ledger node. The distributed ledger node contain a mapping, and the distributed ledger node can submit the query to the mapping.

In block 1406, the query can return an identification of a validation node and/or a validation node address, and the distributed ledger node can transmit this identification to the client node.

In block 1408, the client node can transmit the identification to the client device. After receiving the identification, the client device can proceed with authentication with the identified validation node and/or validation node address, in block 1410.

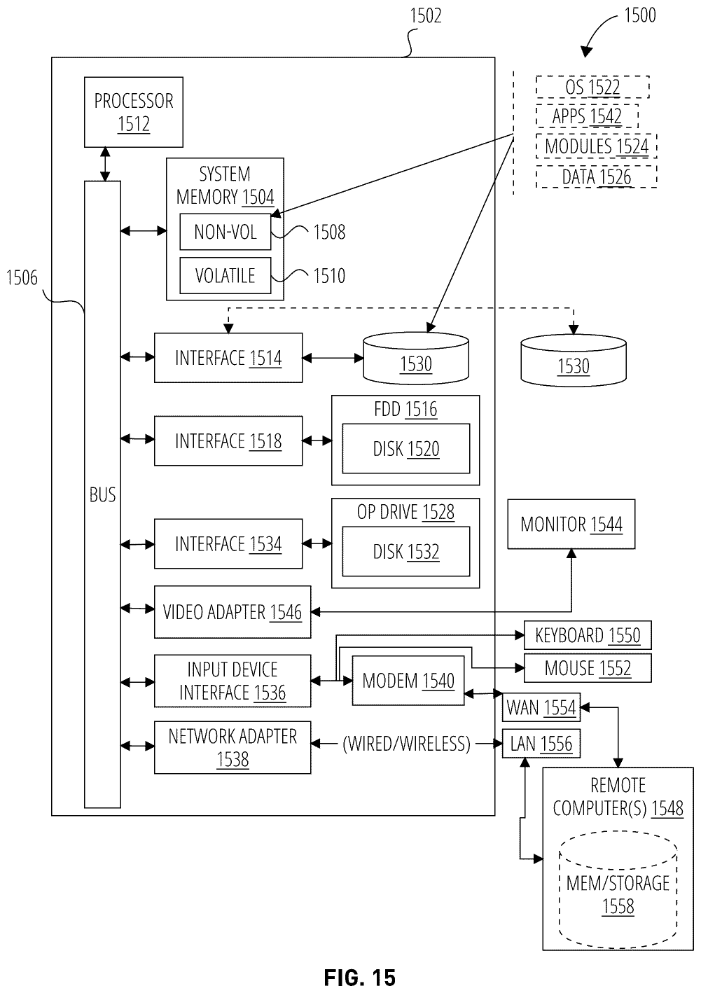

FIG. 15 illustrates an embodiment of an exemplary computer architecture 1500 suitable for implementing various embodiments as previously described. In one embodiment, the computer architecture 1500 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 100.

As shown in FIG. 15, the computing architecture 100 includes a processor 1512, a system memory 1504 and a system bus 1506. The processor 1512 can be any of various commercially available processors.

The system bus 1506 provides an interface for system components including, but not limited to, the system memory 1504 to the processor 1512. The system bus 1506 can be any of several types of bus structure that may further interconnect to a memory bus (with or without a memory controller), a peripheral bus, and a local bus using any of a variety of commercially available bus architectures. Interface adapters may connect to the system bus 608 via slot architecture. Example slot architectures may include without limitation Accelerated Graphics Port (AGP), Card Bus, (Extended) Industry Standard Architecture ((E) ISA), Micro Channel Architecture (MCA), NuBus, Peripheral Component Interconnect (Extended) (PCI(X)), PCI Express, Personal Computer Memory Card International Association (PCMCIA), and the like.

The computing architecture 100 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1504 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1504 can include non-volatile 1508 and/or volatile 1510. A basic input/output system (BIOS) can be stored in the non-volatile 1508.

The computer 1502 may include various types of computer-readable storage media in the form of one or more lower speed memory units, including an internal (or external) hard disk drive 1530, a magnetic disk drive 1516 to read from or write to a removable magnetic disk 1520, and an optical disk drive 1528 to read from or write to a removable optical disk 1532 (e.g., a CD-ROM or DVD). The hard disk drive 1530, magnetic disk drive 1516 and optical disk drive 1528 can be connected to system bus 1506 the by an HDD interface 1514, and FDD interface 1518 and an optical disk drive interface 1534, respectively. The HDD interface 1514 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1508, and volatile 1510, including an operating system 1522, one or more applications 1542, other program modules 1524, and program data 1526. In one embodiment, the one or more applications 1542, other program modules 1524, and program data 1526 can include, for example, the various applications and/or components of the systems discussed herein.

A user can enter commands and information into the computer 1502 through one or more wire/wireless input devices, for example, a keyboard 1550 and a pointing device, such as a mouse 1552. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1512 through an input device interface 1536 that is coupled to the system bus 1506 but can be connected by other interfaces such as a parallel port, IEEE 1394 serial port, a game port, a USB port, an IR interface, and so forth.

A monitor 1544 or other type of display device is also connected to the system bus 1506 via an interface, such as a video adapter 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all the elements described relative to the computer 1502, although, for purposes of brevity, only a memory and/or storage device 1558 is illustrated. The logical connections depicted include wire/wireless connectivity to a local area network 1556 and/or larger networks, for example, a wide area network 1554. Such LAN and WAN networking environments are commonplace in offices and companies, and facilitate enterprise-wide computer networks, such as intranets, all of which may connect to a global communications network, for example, the Internet.

When used in a local area network 1556 networking environment, the computer 1502 is connected to the local area network 1556 through a wire and/or wireless communication network interface or network adapter 1538. The network adapter 1538 can facilitate wire and/or wireless communications to the local area network 1556, which may also include a wireless access point disposed thereon for communicating with the wireless functionality of the network adapter 1538.

When used in a wide area network 1554 networking environment, the computer 1502 can include a modem 1540, or is connected to a communications server on the wide area network 1554 or has other means for establishing communications over the wide area network 1554, such as by way of the Internet. The modem 1540, which can be internal or external and a wire and/or wireless device, connects to the system bus 1506 via the input device interface 1536. In a networked environment, program modules depicted relative to the computer 1502, or portions thereof, can be stored in the remote memory and/or storage device 1558. It will be appreciated that the network connections shown are exemplary and other means of establishing a communications link between the computers can be used.

The computer 1502 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

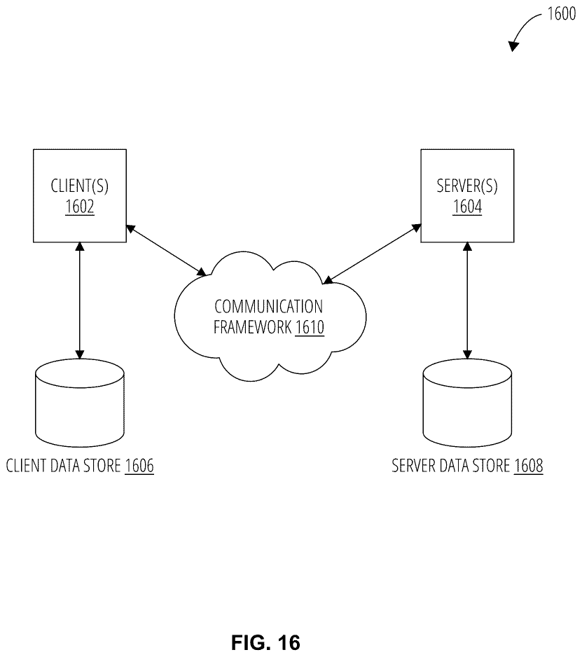

FIG. 16 is a block diagram depicting an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600, which may be consistent with systems and devices discussed herein.

As shown in FIG. 16, the communications architecture 1600 includes one or more client(s) 1602 and server(s) 1604. The server(s) 1604 may implement one or more functions and embodiments discussed herein. The client(s) 1602 and the server(s) 1604 are operatively connected to one or more respective client data store 1606 and server data store 1608 that can be employed to store information local to the respective client(s) 1602 and server(s) 1604, such as cookies and/or associated contextual information.

The client(s) 1602 and the server(s) 1604 may communicate information between each other using a communication framework 1610. The communication framework 1610 may implement any well-known communications techniques and protocols. The communication framework 1610 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1610 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 1602 and the server(s) 1604. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

The present disclosure includes example embodiments using NFC for contactless card communication, but it is understood that the present disclosure is not limited to a particular type of communication. Rather, the present disclosure encompasses other types of contactless card communication, such as Bluetooth, RFID, and Wi-Fi, along with NFC.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A system, comprising:
a switchboard node; and
a merchant server in data communication with a memory cache containing a client private key,
wherein the merchant server is configured to:
receive, from the switchboard node, a signed function resulted token, an issuer public key, a validator public key, a switchboard node public key, and a client public key,
verify the signed function result token using the issuer public key,
extract, from the signed function result token, a signed validation token,
verify the signed validation token using the validator public key,
extract, from the signed validation token, a signed node session token,
verify the signed node session token using the switchboard node public key,
extract, from the signed node session token, a signed client session token,
verify the signed client session token using the client public key,
obtain, from the memory cache, the client private key using a signed client session token,
compute an encryption secret using the client private key and the issuer encryption public key,
decrypt the encrypted function result using the encryption secret to yield a function result,
associate the function result with a client session identifier, and
transmit, to the switchboard node, a success notification.

2. The system of claim 1, wherein the switchboard node is configured to transmit the success notification to a client software development kit.

3. The system of claim 1, wherein the merchant server is further configured to, after obtaining the client private key, remove the client private key from the memory cache.

4. The system of claim 1, wherein the merchant server is further configured to generate the signed client session token.

5. The system of claim 1, wherein the signed client session token comprises a JavaScript Online Notation (JSON) web token.

6. The system of claim 5, wherein the JSON web token contains client session information signed with the client private key.

7. The system of claim 1, wherein the merchant server is further configured to, responsive to receiving the signed function result token:
request, from the switchboard node, the issuer public key, validator public key, switchboard node public key, and client public key,
wherein the merchant server is further configured to transmit the request for the issuer public key, validator public key, switchboard node public key, and client public key prior to receiving the issuer public key, validator public key, switchboard node public key, and client public key from the switchboard node.

8. The system of claim 1, wherein:
the system further comprises an issuer and/or function fulfiller (IFF) client device,
wherein the IFF client device is configured to:
receive, from the switchboard node, a request for a function resolution using the signed validation token, a consent date, and a terms of service (TOS) version,
request, from the switchboard node, a validator public key, a switchboard node public key, and a client public key, and
receive, from the switchboard node, the validator public key, the switchboard node public key, and the client public key.

9. The system of claim 8, wherein the IFF client device is further configured to:
verify the signed validation token signature using the validator public key,
extract, from the signed validation token, the signed node session token,
verify the signed node session token with the node public key,
extract, from the signed node session token, the signed client session token,
verify the signed client session token signature using the client public key,
store the consent date and TOS version,
generate the issuer encryption public key and an issuer encryption private key,
generate the encryption secret using the issuer encryption private key and the client encryption public key,
execute a function request to create a function result,
encryption the function result using the encryption secret,
generate a signed function result token using the issuer private key, and
transmit, to the switchboard node, the signed function result token.

10. The system of claim 9, wherein the signed function result token contains the encrypted function request and the issuer encryption public key.

11. The system of claim 9, wherein the issuer encryption public key and the issuer encryption private key are generated using Elliptic Curve P256.

12. The system of claim 8, wherein the TOS version is associated with a function terms of service (TOS).

13. The system of claim 12, further comprising:
the client software development kit is configured to obtain user consent to the function TOS, and
the client software development kit is further configured to request a tap of a contactless card to obtain the user consent.

14. A method, comprising:
receiving, by a merchant server from a switchboard node, a signed function resulted token, an issuer public key, a validator public key, a switchboard node public key, and a client public key, wherein the merchant server is in data communication with a memory cache containing a client private key;
verifying, by the merchant server, the signed function result token using the issuer public key;
extracting, by the merchant server from the signed function result token, a signed validation token;
verifying, by the merchant server, the signed validation token using the validator public key;
extracting, by the merchant server from the signed validation token, a signed node session token;
verifying, by the merchant server, the signed node session token using the switchboard node public key;
extracting, by the merchant server from the signed node session token, a signed client session token;
verifying, by the merchant server, the signed client session token using the client public key;
obtaining, by the merchant server from the memory cache, the client private key using a signed client session token;
computing, by the merchant server, an encryption secret using the client private key and the issuer encryption public key;
decrypting, by the merchant server, the encrypted function result using the encryption secret to yield a function result;
associating, by the merchant server, the function result with a client session identifier; and
transmitting, by the merchant server to the switchboard node, a success notification.

15. The method of claim 14, further comprising receiving, by the merchant server from an issuer and/or function fulfiller (IFF) client device, the issuer encryption public key.

16. The method of claim 14, further comprising, after obtaining the client private key, removing, by the merchant server, the client private key from the memory cache.

17. The method of claim 14, further comprising generating, by the merchant server, the signed client session token.

18. The method of claim 14, further comprising storing a unique identifier (pUID) associated with a card.

19. A non-transitory computer-readable storage medium containing executable instructions, wherein, when executed by a device comprising a processor, causes the device to perform operations comprising:
receiving, from a switchboard node, a signed function resulted token, an issuer public key, a validator public key, a switchboard node public key, and a client public key, wherein the merchant server is in data communication with a
verifying the signed function result token using the issuer public key,
extracting, from the signed function result token, a signed validation token,
verifying the signed validation token using the validator public key,
extracting, from the signed validation token, a signed node session token,
verifying the signed node session token using the switchboard node public key,
extracting, from the signed node session token, a signed client session token,
verifying the signed client session token using the client public key,
obtaining, from a memory cache, the client private key using a signed client session token,
computing an encryption secret using the client private key and the issuer encryption public key,
decrypting the encrypted function result using the encryption secret to yield a function result,
associating the function result with a client session identifier, and transmitting, to the switchboard node, a success notification.

20. The non-transitory computer-readable storage medium of claim 19, wherein:
the device is in data communication with the memory cache, and
the operations further comprising, after obtaining the client private key, removing the client private key from the memory cache.
